(19) United States
(12) Patent Application Publication
(10) Pub. No.: US 2011/0276993 A1
(43) Pub. Date: Nov. 10, 2011

(54) Media Content Programming Control Method and Apparatus

(76) Inventor: Kenneth H. Ferguson, Great Falls, VA (US)

(21) Appl. No.: 13/187,469

(22) Filed: Jul. 20, 2011

Related U.S. Application Data
(63) Continuation of application No. 11/783,119, filed on Apr. 6, 2007, now abandoned.

(51) Int. Cl. H04N 7/16

(52) U.S. Cl. 725/30

(57) ABSTRACT

A method and system for the control, aggregation, and management of television programming and Internet content (both traditional and video sources) and more specifically to the customization of media choices and content based in part on the dynamic editing of content according to user preferences. Affiliate Groups can be used to mark, recommend or provide selective editing of video and other media that can be received by users. Users may join Affiliate Groups and selectively view or have content automatically filtered from the data received in their premises such that the display of the media is less than all of the media received at the premises based on Affiliate Group recommendations. Menus and displays may be created that show preferred media content, additional content generated by the Affiliate Groups. Channel schedules may be pre-filtered or provide customized warnings about objectionable material.

### CROSS REFERENCE TO RELATED APPLICATIONS

This application claims the benefit of U.S. Provisional Application 60/789,590, filed Apr. 6, 2006, entitled Media Content Programming Control Method and Apparatus, and is a continuation of U.S. patent application Ser. No. 11/783,119; both of which are incorporated herein by reference.

### BACKGROUND OF THE INVENTION

1. Field of the Invention

The present invention relates to the control, aggregation, and management of television programming and Internet content (both traditional and video sources) and more specifically to the customization of media choices and content based in part on the dynamic editing of content according to user preferences. The functionality derives from an innovative meta-data generation and delivery system providing content management at sub-program granularity.

2. Description of the Prior Art

With the profusion of television entertainment programming sources now widely available through broadcast, cable, satellite, and Internet distribution systems, television viewers have an overwhelming variety of entertainment options. As a result of the tremendous variety, viewers find that many of the entertainment options are impossible to find or to navigate without editorial assistance. For example, one viewer may only have an interest in current event programming such as news or talk shows or sports and has no desire to watch children's shows or music videos. Families have the additional requirement of determining and displaying only age-appropriate content depending on time of day, family members present, and other personal and usage patterns and requirements. It would be advantageous for that viewer to be able to have a service that automatically locates, stores and recommends desired programming while at the same time hiding, blocking, filtering or screening unwanted programming.

Some methods of channel selection elimination are known. For example, satellite television uses setup guides and channel categorization as methods for eliminating the display of channel selections by a crude process of eliminating the appearance of channels from the on-screen program guide. A drawback to such a system is that some channels have a variety of programming that may include some desirable and some undesirable programming. Eliminating the entire channel from the onscreen guide also eliminates the opportunity to choose desirable programming from that channel when it is offered.

Thus it can be seen that there is a need for a service and apparatus that can customize program selection options to present to the viewer all desired available programming options at any particular time from all sources while eliminating unwanted or inappropriate channels, programs, and content. This need will increase dramatically as Internet deliver of video content converges with traditional delivery mechanisms (broadcast, cable, and satellite). Without content regulation (broadcasters are regulated by the Federal Communications Commission) and technical and/or economic regulation (broadcasters, cable TV companies, and satellite companies are all regulated at the federal, state, or local level either technically or economically as public utilities) and without the need for economic concentration and resulting large barriers to market entry, there will be a massive increase in the amount of available video programming, and a huge increase in diversity and range of quality of available video content.

Another important video management feature is the modification or elimination of undesirable content that occurs within otherwise desirable programs. Many viewers find certain portions of otherwise entertaining television programs objectionable. For example, elimination of foul language, sexual content, nudity, and violence is necessary to protect children from exposure to potentially harmful content. Moreover, many adults find such scenes unnecessary and detracting from their enjoyment of the program. Sometimes the undesirable content is not limited to the editorial portion of program itself, but can include the commercial advertisements previously inserted and displayed within the programs as well. Prior devices have attempted to accomplish editing using data such as meta-tags to provide a personalized edition of the media program and identify objectionable scenes, but such a system only works when the incoming media stream is encoded by the original content provider. Further, the metadata itself may be compromised by the lack of independence in its creation (such as the MPAA television rating system, which is generated by the producers of the programs), rendering any possible editing system based on such metadata untrustworthy to viewers and therefore of little or no use.

A more effective approach is to separate entirely the creation of editorial metadata from the technical infrastructure and tools needed to deliver and utilize the judgments embodied in the metadata. This allows users of a single technology infrastructure to rely on the editorial judgment of one or more independent affinity or community groups such as parents' organizations, church groups, community and social groups, business organizations, sports clubs, and so forth. The proposed invention provides a robust way of differentiating and assigning and later re-associating user choices with regard to independently-authored editorial content. This involves using a combination of industry-specific identifiers for video/film content (such as those specified in SMTPE standards), URIs/URLs for Internet-based video, and UUIDs and/or URIs (universally unique identifiers and/or uniform resource identifiers) within the system to compactly and uniquely represent editorial content creators and metadata sets and map those reliably to user choices.

Under the proposed invention independently created metadata can use a time index or bookmark or digital “fingerprint” to indicate a point in time from the beginning of the media program or a sub-part of the program. Alternatively, the metadata may reference a frame index, offset, chapter reference, scene reference, or other positional indicator within the media program, including any media sub-stream. The metadata can arrive at the video display device via a completely independent communications channel (such as over a TCP/IP network protocol connection) or a physically-embodied digital medium such as a CD or DVD disc for use after the digital stream embodying the video/audio content has arrived separately at the customer premise equipment (CPE). Or the metadata can be independently embedded upstream of the CPE in a non-intrusively and non-destructive manner within a digital video stream by means of the extensible sub-stream/sub-channel model included in all modern video transmission formats such as MPEG-2 (Motion Picture Expert Group standard 2) transport streams and program streams. In either case, the metadata must interoperate correctly with traditional “open” media streams as well as encrypted and protected media content distributed using “digital rights management” (DRM) tools and supporting infrastructure.

Beyond creation of editorial metadata and its delivery to the CPE either outside or inside the video stream to use with pre-recorded content, another highly useful application of the technology would be real-time or semi-real-time filtering and blocking of video content. In such a system, media editing would be conducted by humans monitoring the video feed at, for example, a central control station whose editorial decisions would result in a control signal or editing command signal being sent by a network to activate or deactivate video display/recording CPE located at the viewer's premises. The human monitors view the same programs and transmit the control signals to all of the subscribers' homes simultaneously. If the video stream is being played with a slight delay, the command signals would reach the CPE prior to the time the undesired content was actually displayed to users. Various strategies are proposed to create and maintain (and, if content is skipped altogether, rebuild) a buffer of streaming semi-real-time content at the CPE. Over time, more powerful computational and “artificial intelligence” approaches can be used to automate or semi-automate (automate with human oversight) the real-time editorial decision-making process.

To obtain such service, the viewer would need to subscribe and permit the service provider to place a control device (whether embodied in hardware or software) on the viewer's video display/recording equipment which would operate in conjunction with the control signal received from the central control station. In this system, the control signal is applied during the broadcast of the station as the program is being transmitted, either live or preferably with a slight delay.

A system capable of combining pre-determined user preferences with editorial metadata in order to locate, aggregate, highlight, and filter or block video content could also be greatly enhanced if the actual behavior of the viewer were fed back into the system via a system-monitored usage-based feedback loop. The proposed invention does just that, maintaining (with the user's permission and with the necessary security and privacy controls in place) a complete history of user media choices and behavior (channel selection, length of time viewing, and another automatically acquired information, as well as optional ratings and rankings of particular viewing choices). This user-generated metadata is fed back into the system, which applies artificial intelligence rules to infer user viewing preferences, allowing the system automatically to provide ever more targeted and customized aggregations, recommendations, and filtering behavior as the system is used. This user data can also be aggregated and jointly analyzed on the basis of affinity groups (AGs) with which the user self-identifies in order to further increase the power of the system. The user can also be notified (based on common elements in their usage of media) of previously unknown social groups with which they may have an affinity.

The system also provides an ideal platform for custom advertising. The system's intimate knowledge of the user's interest and activities-known by information collected directly from the user, from affinity group information, and from data gathered directly from the usage of both video and Internet systems-provides a powerful platform for customized and highly targeted advertising. The system's content editing/substitution technologies-whether utilized during playback of recorded programming or on a “live” content—can be used to substitute advertising dynamically. Finally, the logging of user behavior by software on the CPE will provide an unprecedented the level of detailed feedback available to advertisers.

The notion of “customer premises equipment” is undergoing rapid change with respect to displaying video content. Video content can be displayed not only on television sets directly or via “set-top box” television-centric computers, but digital video recorders/personal video recorders (DVR/PVRs), personal computers and laptops, portable DVD players, portable media players (whether music/audio only or audio/video), mobile phones with multimedia capabilities, and so forth in an explosion of media-capable and increasingly interconnected digital devices. The proposed video aggregation, recommendation, and filtering technologies will be applied to other non-traditional devices as the system is enhanced to include them within its purview.

Although individuals and families have special needs with respect to the finding, managing, and filtering/blocking video content from all sources, most users will also be using non-video Internet content at the same time and often on the same device or closely related devices. “Internet content” includes, but is not limited to, web pages made up of text, pictures, audio, embedded video, etc.; email consisting of similar content types; instant messages consisting of similar content types, and so forth. There is a major overlap between users' interests and concerns regarding video content and their interests and concerns regarding Internet content. Thus the proposed invention will manage Internet content using the same knowledge base about the user's interests and concerns as it uses for video services. As with video usage, the user's Internet usage patterns will be aggregated into the same knowledge base and analyzed in order to improve the delivery of desired content and the filtering or blocking of undesired content, as well as improved recommendations and filtering in the video service (for example, if the user is using the Internet to do browsing on automobile racing, the video system will automatically record and propose to the video user programs on that same topic). In addition, the Internet usage behavior of large numbers of people who self-identify with one or more AGs can be used to further customize aggregation, recommendation, and filtering, since it is likely that users within self-chosen AGs will have similar interests, preferences, and values with respect to Internet content.

With regard to the technological approach to Internet content management, the proposed invention will install no software (or minimal software) on client computer systems. Instead, it will run all of the aggregation, filtering, and usage-capture logic on network-based servers that logically sit between the client computer and the Internet. This approach has many theoretical and practical advantages, and is fundamentally enabled by the fact that the users' video service provider (VSP) is also likely to be their Internet service provider (ISP), and thus it is straightforward for the proposed invention to place the “business logic” of Internet content aggregation and filtering in the edge network operated by the ISP. However, even in cases where users choose to use the Internet from other locations outside the home, a very small layer of software installed on their computers could be used to enable network-based content management and filtering.

In view of the foregoing, it will be seen that there is a need for a system that provides highly customized video content management, aggregation, recommendation, and filtering for use by subscribers to broadcast, cable, satellite, and Internet-delivered video, as well as associated non-video Internet content. The power of the system is dramatically multiplied because users will be encouraged to associate with one or more AGs, whose aggregate behavior can be used to further customize the system for each individual user or group of users (typically, a single household). Users of the system set the parameters of the system and can be allowed to choose to by-pass it, so rather than in any way restricting the use of media the system enhances user choice and provides more viewing and media management options than are currently available.

None of the prior art, taken either singly or in combination, is seen to describe the instant invention as claimed.

### SUMMARY OF THE INVENTION

An object of the invention is to achieve a means of pooling all available content delivery systems and screening and customizing the content available according to the subscriber's tastes and viewing conveniences to empower the consumer to have more personalized control over their media selections.

An object of the invention is to provide to viewers an ability to receive an entertainment signal with an editorial application service capable of selectively screening out unwanted content.

Another object of the invention is to provide a live editorial application service that can promote programming content, which better serves the individual subscriber.

Yet another object of the invention is to provide broadband delivery systems for content delivery.

Still another object is to provide electronic circuitry to receive signal input from both a television programming provider such as cable or satellite and a broadband connection for receiving content editing services.

It is a further object of the invention to provide a system capable of editing and selecting media content provided by broadcast systems such as television, radio and computer networks such as the Internet.

It is another object of the invention to provide various levels of selective screening of content, which selectively allow full viewing of modified viewing of the same content.

Yet another object of the invention is to provide to subscribers a customized on screen programming guide which displays only desired programming as well as offering additional recommendation information to further personalize to the subscribers unique needs.

Still another object of the invention is to provide to subscribers edited playback of programming, which deletes undesired scenes and language from television programs after broadcast of the original programming.

Yet another object of the invention is to provide a personal video recorder that receives and records an entire program so that a subscriber can receive and store programs that match their unique needs and interests.

Another object of the invention is to provide to subscribers Internet based programming content in addition to television programming content on the same television screen.

These and other objects of the present invention will be readily apparent upon review of the following detailed description of the invention and the accompanying drawings. These objects of the present invention are not exhaustive and are not to be construed as limiting the scope of the claimed invention. Further, it must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

In summary, the invention is directed to a custom television programming service with human editors evaluating and editing the playback of television programming content. Preferably, the editors evaluate each program individually for content based upon viewer expectations. Programming may be modified during playback to exclude objectionable subject matter, including scenes or language. An onscreen programming guide is displayed that preferably indicates programming meeting predetermined content preferences as well as automatically recording and storing those programs that meet predetermined criteria and evaluation by the live editorial desk specializing in the content genre (not unlike a newspaper service organizing its editorial desks by genre of interest). The onscreen programming guide includes a listing of programs that have been previewed and predetermined to meet the subscriber's expectations of programming content. Programming such as weekly television shows that normally meet content expectations can be displayed with a highlighted color when such shows contain objectionable subject matter. Editing functions can be overridden using an administrator access code.

It is an object of the invention to provide improved elements and arrangements thereof in an apparatus for the purposes described which is inexpensive, dependable and fully effective in accomplishing its intended purposes.

These objects of the present invention are not exhaustive and are not to be construed as limiting the scope of the claimed invention. Further, it must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

These and other objects of the present invention will become readily apparent upon further review of the following specification and drawings.

### BRIEF DESCRIPTION OF THE DRAWINGS

FIG. 1 is a diagrammatic view of the overall system according to a preferred embodiment of the invention.

FIG. 2 is a diagrammatic view of the overall system according to a second embodiment of the invention.

FIG. 3 is a diagrammatic view of the set-top box/digital video recorder (STB/DVR) client software architecture and functionality.

FIG. 4 is a diagrammatic view of the editorial meta-data creation, distribution, and usage process.

FIG. 5 is a diagrammatic view of the Internet content management and filtering subsystem.

FIGS. 6A&B are to a table showing meta-data types and media types and their interrelation.

Similar reference characters denote corresponding features consistently throughout the attached drawings.

### DETAILED DESCRIPTION OF THE PREFERRED EMBODIMENT(S)

1. System Overview

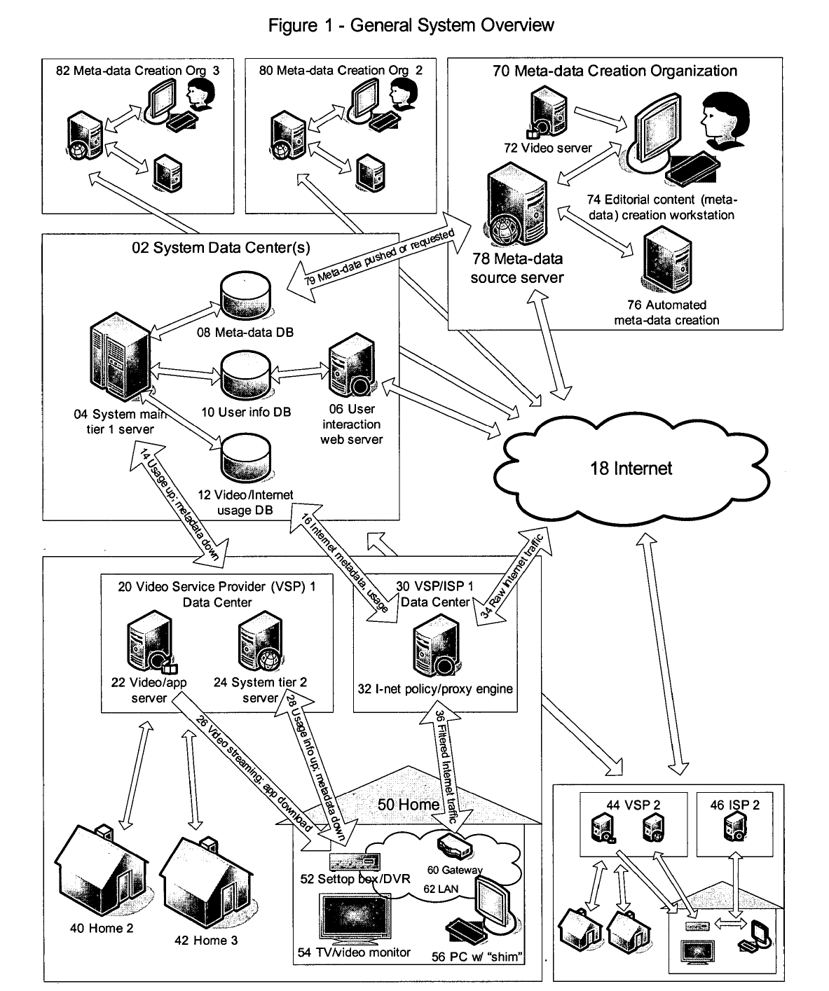

As depicted in FIG. 1, the preferred embodiment of the invention includes a number of components and subsystems. At the heart of the system is a centralized data center (02) at which a large fault-tolerate server cluster (04) manages and orchestrates three databases: rich supplementary information about video/audio/multimedia sources that describes its contents in a structured fashion (“meta-data”) (08), user-supplied information about himself/herself and family as well as their affinity groups (“user information”) (10), and records of the user's multimedia and Internet usage behavior (“usage information”) (12). Alternatively, to achieve massive system scale, the data center (02) can be regionalized and remain “close” to a geographically restricted set of users, with a “single image” multi-master replicated database used for meta-data (08) and only certain crucial but limited system-wide parameters stored across datacenters in a replicated multi-master fashion with respect to user information (10) and usage information (12).

To make use of the invention, the user would contact either his/her video service provider or the system provider to initiate the service. The initial contact to acquire the system could be made by telephone or using a computer system. But even if initial contact is by telephone, preferably the user will utilize some kind of computer system, whether personal computer (PC) or set-top box (STB) video computer, to configure and deploy the system, for example to upload the user's preferences to the system.

In its preferred embodiment the user uses the software and services that are parts of the invention to acquire and activate the service provided by the invention. This approach is preferred because the system needs to acquire a significant amount of information about the user. Some of that information need is ameliorated by the user's self-identification with an AG (as discussed below). But a better approach is to use the system itself to create a user account and begin a series of automated or semi-automated processes that result in the full deployment and usage of the system.

The preferred “boot-strapping” model for using the system to configure and deploy the system is based on the ubiquity of the Internet and world-wide web. The user would connect to the Internet and use a web browser on use his/her PC (56) to attempt to create a new system account via a system-provided web server (06). The system would ask the user to identify his/her video service provider (VSP). If the system has the appropriate partnership with the user's VSP, the account creation would be permitted. The user would then have an account created within the main system database (10). If the user's VSP is not a partner, a suitable VSP may be recommended, or the refused subscriber's (non-personalized) data could be used as evidence to the VSP to subscribe to the invention's concepts and systems.

Another “boot-strapping” model for deploying the system would be to use the interactive TV features provided by some (but not all) VSPs. In some systems, users are able to browse, purchase, and download new applications to their STB (52). The system of the present invention would preferably be listed as a downloadable application from the VSP application server (22), the user would purchase (“license”) the service, software or application, and the system would download (26) and initialize the client application. When started, the client application running on the STB (52) may then initiate an interaction with the user in order to acquire the needed information, upload the acquired information to the system server (04) (preferably via the tier 2 server (24), which would in turn upload the information to the main system server (04)), which would then be able fully to configure and deploy the service.

Whether signing up for the service via a web browser or the more limited user interface provided by a STB application, the user would preferably initially enter his/her affinity group (AG) (if any) or groups (church/mosque, parents' organization, community groups, sports groups, etc.), allowing the system to create a number of reasonable default settings based on information provided by the leadership of the AG. Alternatively, non-AG, non-group default selections could be provided as options or a questionnaire could be provided to select, change or accept system defaults.

AGs will have pre-created their accounts in the system so that as subscribers join, they may select one or more AGs of interest. An AG can choose to be open (anyone can join) or closed (the user must provide credentials to join), and those policies would be applied as appropriate to the initial user registration. AGs have a strong incentive to invest in the system because they are provided their own “virtual channels” for content distribution to their target audiences. “Virtual channels” are simply mechanisms within the system invention by which the digital video content produced by or otherwise of interest to the AG are delivered to the user's set-top box/digital video recording (STB/DVR) device (52) and presented to users in a manner almost identical to broadcast TV channels delivered by standard means. As described in detail in Section (6), AGs that also create meta-data for their members are given the functional name “meta-data creation organizations” (MCOs) in the system overview diagram (70, 80, 82).

Beyond the already partially customized settings provided by his/her initial choice of AGs, the user would also provide the system with as much additional information or customization data as he/she is willing to provide, such as family members (each of whom can in turn have customized system settings), their ages, hobbies and avocations, media and entertainment interests, and level of content filtering desired (high, medium, or low) and in which appropriate categories (for example, separate settings for nudity, sexual content, violence, and portrayal of alcohol/drug abuse), and user's ability to opt out of or change system settings and functions (such as filtering). The user would also configure settings appropriate to Internet content management and filtering, and optionally create managed and filtered email accounts, home pages, photo and video-sharing sub-sites for his/her family members, and so forth. The shared data portions (which may or may not be filtered as well) of the account such as, for example, uploaded photo and video content, can be automatically shared with members of an AG (this would be typical of a closed group), or the system can require that individuals receive permission from the user even if they are members of the same AG (typical of an open group). The user may also create the appropriate accounts and passwords that would allow the systems various content filtering features to be by-passed or altered as needed and appropriate.

Once the account is created using the preferred method (web-based from PC (56) to system web server (06)), the system would optionally download to the PC a small piece of software (“client shim”) that subsequently would be utilized to enhance the overall performance of the system in several respects (detailed below). The system server (04) would then notify the VSP that the user has signed up for the service. This could be done in an entirely software-driven, automated fashion if the IT infrastructure of the VSP is sufficiently sophisticated and network-connected. The VSP datacenter (20) would then push down the client portion of the invention to the user's STB/DVR (52) which would automatically install it (automated client software push and installation is a reasonably ubiquitous feature of modern digital TV systems).

At the same time, the main system server (04) would push down an appropriate subset of the acquired user information (10) to a respective tier 2 server, if any (24) located within the VSP datacenter and private network (20) where it is fully accessible to the STB/DVR (52). The interaction between the main server and the tier 2 server would take place over a private (or encrypted virtual private) network connection (14). As a result of this downstream replication, the bulk of interaction between the system and the STB/DVR would take place in a relatively “local” way between VSP datacenter (20) and the home (50), which is of course only one of many thousands of homes (40, 42) potentially using the invention within a single VSP environment. The VSP is, in turn, only one of dozens or hundreds of additional VSPs (44) that also provide the service that is the preferred embodiment of the invention.

Once installed, the STB/DVR client portion of the invention (“STB client”) would immediately undertake a number of steps to explore its environment and begin to customize the user experience. This is especially helpful to determine alternate or better communication methods available between the system and the user, such as broadband Internet connections.

First, the STB client would contact the system tier 2 server (24) located at a pre-configured network address within the private IP network operated by the VSP. The client would register itself and pass up to the tier 2 server relevant information such as its own hardware and software capacities and levels, its IP address and media access control (MAC) address, relevant installed software and hardware, etc.

Next, the STB client would examine local network connections and determine if it had any additional connectivity, such as a connection to the home local area network (LAN) (62). If this connectivity were available, it would then try to connect to the system datacenter (02) through the default gateway on that subnet. If successful, the STB client has auto-discovered an alternative path (36, 34, 18) to the main system server, as well as to other Internet resources. And the system server will have discovered and stored the client IP address, which is most likely the public address of the home gateway (60) due to almost-universal use of network address translation (NAT) in home environments. This data can be used in a number of useful ways. For example, if a browser client connects to the system servers from the same public IP address as an STB client, the system will know that the STB client and the web client are co-located behind one or more NAT devices (60), most likely on the same LAN (62). Conversely, if account modifications take place from a different IP address than the public IP of the STB client, the servers can note the discrepancy and possibly log it, allowing (for example) a parent to be aware of modifications to the account were made or attempted from a non-home-based computer.

Whether or not Internet connectivity exists, the STB client would then preferably broadcast to the subnet and capture the MAC addresses of all devices within the broadcast domain (typically, the home LAN). If the “client shim” system software is resident on one or more PCs, it would respond to a special broadcast and identify itself to the STB client, thus enabling the STB client to find an associated PC in a totally automated way, even if there is no Internet connectivity via the LAN. That PC can later serve as the source of multimedia content for display and interaction from the STB client.

Next, the STB client would upload its VSP-provided, as well as home LAN, MAC and IP addresses, the MAC address and account identifier returned by any discovered “client shim,” and (assuming the user has given permission for maximal network discovery when setting up his/her account) all other MAC addresses discovered on the LAN through the tier 2 server (24) to the main server (04). Since MAC addresses are (in general) globally unique identifiers, this stored data can be utilized to auto-discover and associate in-home (50) resources during the course of the usage of the entire system, including not only the video service but the customized Internet content management and filtering sub-service as well.

While this auto-discovery and auto-configuration work is going on, the tier 2 server (24) will be downloading to the STB client (52): (a) customized “home page” content appropriate to the user and his/her interests, (b) the meta-data provided by an AG editorial team (70, 80, 82) as needed to modify the electronic program guide (EPG) that is normally provided by the user's VSP, and (c) a welcome video from the system itself and/or a welcome video from the user's AG(s). These operations and their results will be examined in greater detail in Sections (4) and (5) below (“User premises functionality”). But before examining the preferred embodiment of the invention at the user site, an alternative architecture for the overall system will be described.

2. Alternative System Architecture

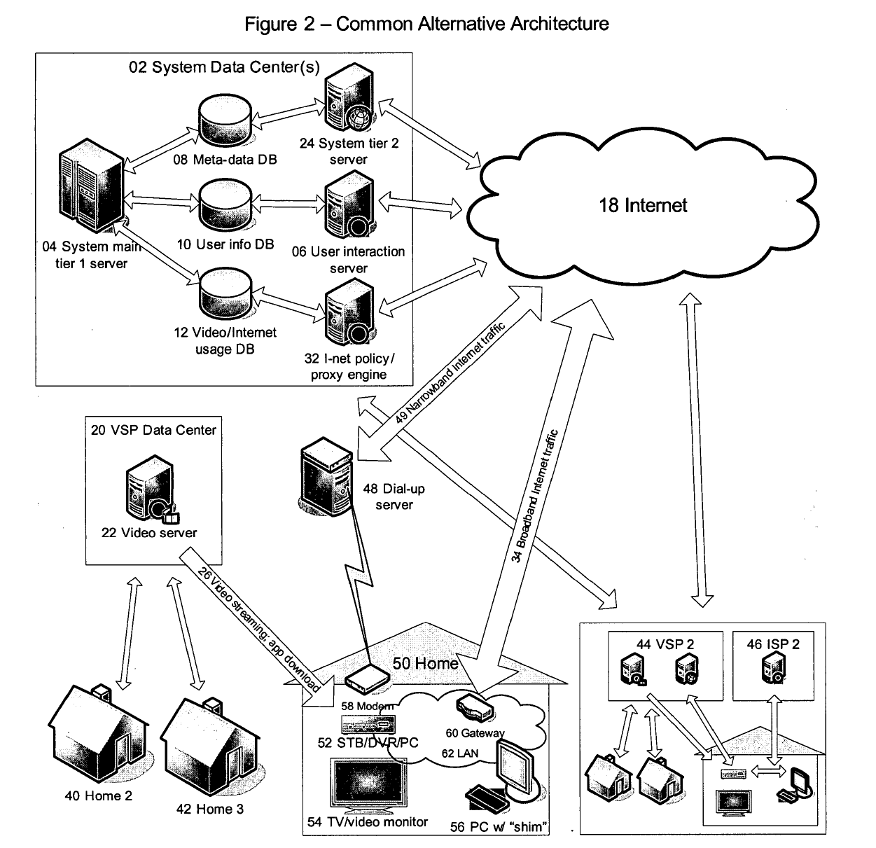

So far the system invention has been described in terms of a preferred embodiment, in which a three-tiered model is employed and the VSP is a necessary partner in the development and deployment of the system. As an alternative, the system can be deployed in a more “free-standing” way in which the cooperation of the VSP is not necessary and the system works completely independently of the video delivery system and mechanism. FIG. 2 shows a diagram of this alternative architecture. The alternative in turn has two sub-alternatives, one based on relatively high-speed and more or less continuous Internet connectivity (“broadband”), and the other based on slow and intermittent network connectivity (“dial-up”).

In the alternative architecture, the video receiving and playing device on which the invention client software is running is not a STB provided by a VSP but some kind of alternative TV device generically called a STB/DVR/PC (52), either (a) a dedicated piece of video display and playback hardware with local storage provided by the system provider with the requisite client software pre-installed; or (b) a special-purpose PC-like computer running a standard operating system like Linux, Apple Computer OS.X, or Microsoft Windows and dedicated to the STB/DVR function; or (c) a more general purpose PC running one of those operating systems and powering the television monitor but capable of more full-function usage as well; or (d) some other plausible alternative computer capable of running the system client software.

In the case of (a), the client software is bundled with the hardware. The user would purchase both the hardware and the service either at a retail store or website, or directly from the system provider by logging in to the systems user interaction server (06) from a PC (56) via the Internet (18). In either case, the user's system account would be pre-created and associated with the hardware ID (MAC address or other UUID) of the device. After the hardware arrives at the home, it would be unpackaged and connected to the video system (20) via coaxial cable (or other television system medium) and also connected either to a phone jack for dial-up access, or to an existing LAN (62, wired or wireless) in the home (50) for access to the Internet. The client application would connect to the user interaction server (06) and automatically associate itself with the user account by hardware ID. All preconfigured options for hardware/software device would then be downloaded and installed.

In the cases of (b) or (c), the user would install the system client application on the hardware/OS using OS-specific tools and techniques. These might include inserting a CD/DVD or USB drive containing the client software and following the auto-run/auto-load model of the client operating system to install and start the system client application. In this case the system client application would provide the user with a hardware ID to manually associate with his/her user account. After that process was completed via web browser (56) and system web/database server (06, 10), then the client application could auto-configure as above.

In the case of (d), techniques similar to the above would be used to minimize user configuration and automate the process of setting up the system as much as possible.

Once the client software is installed and operating on the STB/DVR/PC (52), no further differences in the four kinds of devices will be discussed, as they will not be material from the perspective of the system invention and its preferred and other embodiments.

3. Alternative Architecture: Broadband Versus Dial-Up Connectivity

There are two different ways the system would operate in the case of having broadband (60, 62, 34) versus dial-up (58, 48, 49); access to the Internet. The broadband case is a superset of the dial-up case all system features are available in the broadband case, but only some will work in the dial-up case due to the dramatically reduced bandwidth.

Broadband sub-architecture: In the broadband case, most or all features available in the preferred embodiment (three-tier architecture working with a VSP) are also available; however, some feature may not work as easily or as well due to lack of cooperation from the VSP. In particular, all meta-data must be downloaded from the tier 2 server (24) which now must be accessed via the Internet. No meta-data can be inserted into the video broadcast stream, and certain additional challenges may arise, such as less consistent and reliable network access and download speeds for system content or AG content to be displayed on “virtual channels.” Similarly, user usage information must be uploaded from the client device (52) to tier 2 server (24) in a more unpredictable and less reliable, and possibly lower-bandwidth environment (although in some cases the upload bandwidth can be higher via the Internet; but in that case, in the three-tier preferred embodiment the speed difference would be discovered and the Internet path (FIG. 1, 36, 34) be used instead when available). Moreover, the semi-real-time meta-data required to be delivered quickly and reliably (see detailed discussion in Section (8) below) from a central real-time editing facility (FIG. 1, 70) will be harder to engineer and scale without the benefit of the private VSP network and a three-tier architecture. The VSP architecture allows for the highly scalable technique of reliable multicasting from the head-end to a large number of client devices, something not feasible over the Internet. Nevertheless, the broadband deployment of the system will have general feature parity with the three-tier preferred embodiment since even in the preferred embodiment the STB (52) is typically the location of the integration of broadcast media and EPG data with system meta-data and system-supplied video and other content.

Dial-up sub-architecture: The dial-up case is quite different. Here, only small amounts of meta-data can be reliably distributed in a timely fashion. Also, possibly less than the total amount of captured usage information can be uploaded. Probably no “virtual channel” video content can be downloaded due to constrained bandwidth. Semi-real-time control data will also likely not be possible in such an environment. In this case the system would still provide a number of useful features, such as a highly personalized and customized EPG based on personal and AG data, edited playback of pre-recorded TV programs (such as re-runs), and edited playback of video-on-demand movies (which would be partially or fully cached locally on the STB/DVR/PC and played back in an edited fashion). But other features such as “virtual channels” and semi-real-time editing of live broadcasting would not be available.

4. User Premises Functionality: An Overview

The preferred embodiment of the invention provides a range and combination of new capabilities to the STB/DVR device through the system client software and supporting infrastructure.

From a content filtering and blocking perspective, the most fundamental concept is to leverage the growing power of the STB/DVR, which is now becoming a powerful computer with ample persistent storage and sufficient computational ability to modify dynamically and ephemerally all media content as desired by the user before display. This is accomplished independently from the production and distribution of the content.

The customer premises equipment (CPE) approach may avoid copyright and economic control issues (such as content distribution contracts forcing the bundling of multiple unrelated media streams) that have traditionally hampered and disempowered users from getting the media content that they desire, as opposed to what the powerful producers of media content want them to consume. In the preferred embodiment of the invention content modification is accomplished after all distribution contracts have been fulfilled (the content has been delivered to the user's media device). Moreover, under copyright law the user has the right to make temporary copies for private use (for example, time-shifting), and also the right to make ephemeral modifications of playback of copyrighted content. For example, the Family Movie Act of 2005 modified the copyright laws explicitly to allow automatic, ephemeral modifications of digital content as it is played in a consumer device. Finally, the user has an obvious First Amendment right not to watch undesired content: no one can be forced to watch portions of an entertainment program that they deem undesirable. Thus it cannot be claimed that it is illegal to use technological means to accomplish the same result that could be accomplished by more crude, manual methods (such as shutting off the TV set or turning off the sound temporarily while offensive content is being displayed).

Filtering is important and uniquely accomplished in the preferred embodiment of the invention. But it only one of the important feature as far as users are concerned. While users have a strong interest in controlling, filtering, and blocking undesired content, they have an even greater, more positive interest in finding and consuming positive, desirable content. As it is today, the typical video system provides consumers with hundreds of channels and very poor tools for finding and watching or recording desirable content. The coming convergence of traditional TV distribution and Internet-based video will make the problem far worse. The user/consumer needs a trusted and knowledgeable source of information about the content that they are likely to find not only acceptable, but highly desirable and enjoyable. A happier user/consumer will be created since targeted advertising can be delivered by the system to users whose interests, preferences, habits, and even times of life (car buying time, wedding time, off to college time, and so forth) are known by the trusted content management system.

An important aspect of the preferred embodiment of the system invention in a pluralistic society is the separation of technology and functional delivery of capabilities via meta-data from the non-technical opinion and judgment required to create the editorial meta-data. The user must trust the technology company building and delivering the service, but even more the user will trust the editorial judgment (both filtering and recommending) of the affinity group or groups that he/she voluntarily selects when signing up for the service, and who likely were instrumental in convincing him/her to sign up for the service in the first place.

Since the technology described herein is functionally distinct from the human judgments that it is designed to deliver, and since it can deliver multiple sets of judgments embodied in different sets of relevant meta-data, the system is capable of providing what is needed in a modern democratic society.

As noted above in “Background of the Invention,” the system also uniquely meets the commercial needs of a highly market-driven society. A large amount of the entertainment created and consumed today—essentially all of the programming on broadcast and cable TV channels—is paid for by advertising. Yet advertisers cannot narrowly target the customers that would most likely be interested in their products but must “shotgun” their message to a broad audience hoping that enough interested people are watching to justify their investment. Moreover, some of their advertising (such as ads dealing with male sexual dysfunction or violent movies or TV shows during family-oriented programming such as major sporting events) is actually offensive to many of their viewers, thus creating a problem far greater than disinterested viewers-hostile and unhappy viewers.

The system invention provides a platform for totally custom advertising based on the system's intimate knowledge of the user's interest and activities. This information is collected directly from the user and also collected or inferred from their membership in affinity groups. That core database is supplemented by the usage of the system. As the user surfs and watches video, and surfs and utilizes the Internet, their usage of those systems is collected and stored by the system for later analysis. For example, if the user is searching for information about “Ford Explorers” on the Internet, that behavior is captured and stored. Later, this collected information can be used by the video side of the system for highly targeted advertising. The system's content editing/substitution technologies (discussed in more detail below) can also be use to dynamically substitute more desirable or more directed advertising. Finally, the level of detailed feedback available to advertisers is unprecedented: Advertisers can know whether the user watched the ad or skipped it or changed the channel, and at what point in the ad the user lost interest.

Finally, from a usability perspective, while many important and real-time options are configurable using a remote control connecting to the STB/DVR, all configuration options for the STB/DVR (and every other aspect of the system) will be available by logging into the system web site (15) from anywhere in the world using, for example, a rich web client interface. This will greatly enhance the usability of the system, which may be too complex to configure entirely from present, TV-based remote control interface.

5. User Premises Functionality: Architecture and Function

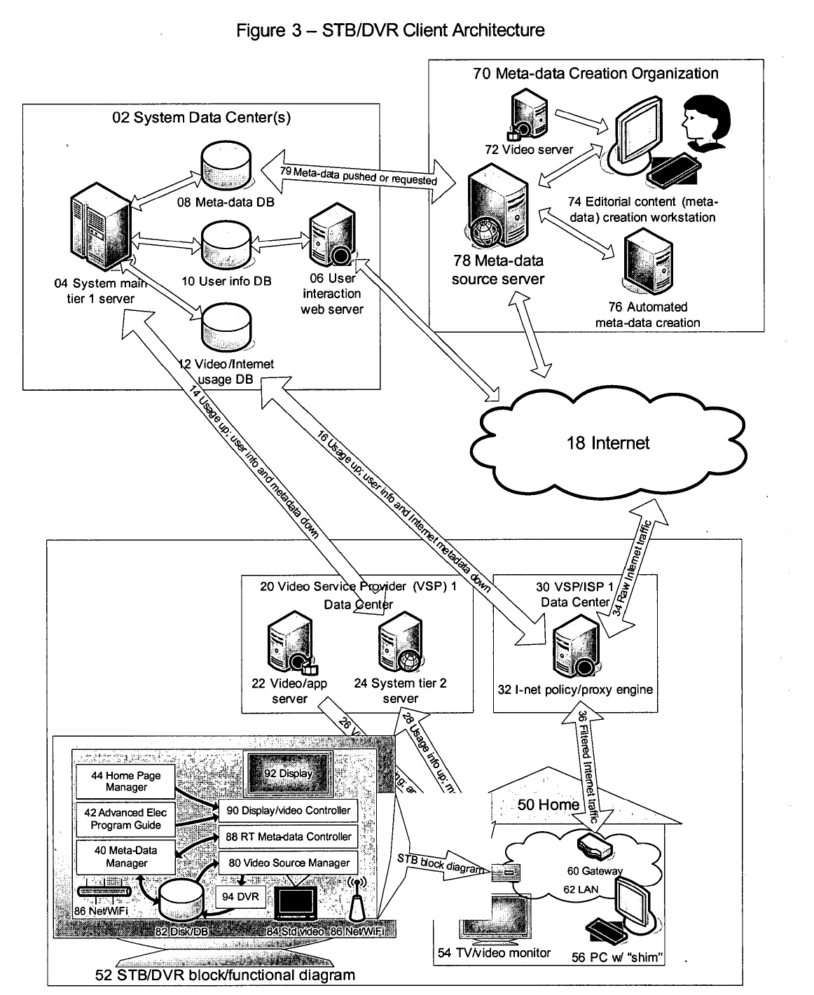

The preferred embodiment of the system includes a set-top box/digital video recorder (STB/DVR) device running the system client software (STB client). FIG. 3 shows additional details about the STB client. The STB/DVR (52) is, in the typical case, the junction point for unaltered television programming and advertising in the form of digital streams coming from a VSP (20, 22, 26), and a set of meta-data developed for the system by one or more meta-data creation organizations (MCOs) (70) and delivered to the system via a private or virtual private network link (79) into the system's meta-data repository (08). The editorial meta-data is then delivered via a private or virtual private network link (14) as needed to the VSP head-end/datacenter (20), and pushed out to STB clients by the tier 2 server (24) via unicast or multicast delivery (28) from the tier 2 server to the STB client.

In an alternative embodiment in which the VSP is not involved with the system, all meta-data is delivered to the STB client by means of the Internet (FIG. 2: 24, 18, 34, 60, 62, 52 (broadband path)), as discussed above in Sections (2) and (3).

Also, in alternative embodiments the editorial meta-data is inserted into the video/audio stream up-stream of the STB client. Those options are discussed in Section (7) below.

The STB client logic and architecture is as follows. First, the STB client includes a set of manager application modules that provide the framework for the real-time and semi-real-time behavior of the system. The meta-data manager (MDM) (40) receives via the wired or wireless network (86) a set of editorial meta-data that maps to electronic program guide (EPG) data and to video content. Unique identifiers (discussed below in Sections (5) and (7)) for EPG data and video program data provide a key in the meta-data database that allows for editorial meta-data to be quickly and accurately related to the standard EPG and video program data coming proximately from the VSP and ultimately from EPG producers or television channel producers such as NBC, CNN, ESPN, etc.

In the case of the EPG, the editorial meta-data consists of records that reference a channel and the programs within a channel. The records contain additional ratings information about channels and programs that are much more granular and (if the MCO is doing a good job) much more accurate than the simple ratings system used by the industry (for example, TV-13 and the basis for that rating such as “sexual themes,” “violence,” etc.). In addition, the MCO will (optionally) provide two reviews of the program: a general one for all users that summarizes the program and rates its quality; and a second one specifically for parents that discusses in detail any issues with the program that might make it unsuitable for children, as well as counterbalancing factors such as artistic quality and other positive elements, giving a reasoned explanation for why the MCO considers the content suitable or unsuitable for children of a certain age range, thus allowing parents to make a final decision. Finally, the meta-data coming from the MCO can also be the equivalent of completely new EPG data records which reference content and programming not found at all in the industry EPG, such as Internet-based video, or (most importantly) MCO/affinity-group created video programming. These records will have their own unique “channel” ID, standard ratings and other meta-data, and URI/URL pointing to the content source. The system will use these records to create the “virtual channels” that are an important part of the positive user experience of the system. These “virtual channels” are also important to the success of the system in that they provide one of the primary incentives for AGs to become (or contract with) MCOs to create meta-data and to add to the “network effects” that can make the system commercially viable and successful.

In the case of video program data, the editorial meta-data consists of records that reference a particular television program or movie by industry-standard unique identifiers along with standard fields such as name, producer, industry-providing program rating, and so forth. The meta-data also includes time-based information about program sub-sections (“incidents”) within the video/audio streams. Each incident record includes the following data: (a) start time, end time; (b) media stream (video, audio, both, or alternate stream); (c) type of incident, rating of incident; (d) optionally, proposed incident alternative (blank screen, skip scene, obscure (portion of) video or audio, or substitute video/audio stream); and (e) pointer (URI/URL) to substitute content (along with flags to describe characteristics of alternate media such as to whether content is locally available as well as media type). As to the last item: when processing this meta-data as an incoming submission, the system meta-data server (08) will preferably use best efforts to obtain the substitute content stream and download that to the STB client along with the structured meta-data. At each step of the processing and download the characteristics flags will be updated to reflect the substitute content's local availability and state.

Meanwhile, the system has already downloaded user preference information to the STB client from the user info database (10) via a private or virtual private network link (14). The MDM (40) processes and stores that user preference information in the local disk/DB (82). With both a local copy of relevant meta-data, and the requisite user information and preferences, the MDM is now ready to provide editorial decision services to the other parts of the STB client system.

The first client application module requesting services from the MDM is the Home Page Manager (HPM) (44). This application can be configured to take over the screen each time the television system (or STB) is started; or it can be configured to overlay the most recently watched previous channel; or overlay a default channel; or be accessed by depressing a button, for example on a remote or the STB. The HPM provides the user a system overview, relevant news (as determined by AGs/MCOs), movie and TV recommendations (same), feedback on previous requests (such as which requested movie downloads have arrived), warnings (such as any suspicious account activity, times when the system devices have been off-line for no clear reason, or recurring attempts to access inappropriate content in the video or Internet content systems, or other system messages), and access to all account information and customization. The HPM calls the MDM to obtain the data needed to fill in these standard categories. The HPM also registers a notification mechanism with the MDM through which the HPM can receive and display real-time system alerts and events generated by the MDM (or its other system clients) at any time.

The second client application module requesting services from the MDM is the customized, searchable EPG, hereafter known as the Advanced Program Guide (APG) (42). The APG utilizes standard EPG data but also merges in changes to EPG data as supplied by the MDM before displaying EPG data on-screen. The APG can be configured as a sub-screen of the HPM or can take over the screen to maximize usability; it can easily be “zoomed” in and out of full screen mode. The APG is responsible for the customized on-screen display of industry-standard programming information, as well as user-initiated searching and filtering (such as “show all basketball games in the next week”). The APG can show channels in any order of preference as configured by the user or the user's AG(s), and/or based on past usage and predicted future usage. The views include pre-configured outline views, ratings views, recommendation-based views, filtered (search-based) views and outlines, and sorted views (such as a sort on an actor's name), all with “explorer-like” tree-structuring applied to the row and column data based on key fields and sort indices.

Thus the APG provides a completely customized view into EPG data, a view determined ultimately by one or more MCOs (70) and proximately by merging EPG data with MDM-supplied meta-data. The meta-data can contain supplementary or completely new or over-riding meta-data about programs and movies, such as the detailed description of a program that is part of the standard EPG data. The APG may utilize a simple (and configurable) color-coded system to indicate which content is likely to be most desirable and which is possibly of concern to the user and his/her family (highly problematic content is not shown at all).

The APG can also pull in content from local computers or can merge data from different sources (such as multiple VSPs), if the STB client is connected to the household LAN or other input sources (such as other VSPs). The “client shim” software for the video system running on local PCs (56) can interact with the HPM and the APG such that locally-available computer-based content (movies, photos, music, and even email and instant messaging) is also available on the STB client. The HPM and APG can also manage playback of local DVD movies and other video content (whether accessible from a DVD drive built in the STB/DVR device itself, or accessible over the home LAN from a personal computer or some kind of dedicated player, networked (e.g., USB or IEEE 1394 FireWire) or otherwise connected (e.g., via HDMI cable)) using the same meta-data scheme and editorial skip/substitute model that is used for broadcast and cable content.

The interaction between the HPM (44) and APG (42) on the one hand and the MDM (40) on the other involves data that is relatively static and infrequently updated. For example, other than news, most of the inputs to the HPM and APG will be based on data that is 24 or more hours old. Thus, in an alternative embodiment the merging of user information and preferences with programming information and MCO data as displayed by the HPM, and the merging of industry standard EPG data with MCO-provided meta-data as displayed by the APG, could in principle occur upstream of the STB client. For example, most HPM content could be created in the system data center (02, 04) or tier 2 server (24) and downloaded to each client on a daily basis; or the APG could be created at the first or second tiers and downloaded to each client. Or, the EPG and MCO-provided meta-data could be processed up-stream of the EPG without considering user-specific information since there would be a relatively small number of resulting customized EPG outputs, and the user-specific customizations could then be pushed down to the STB client. However, the preferred embodiment takes advantage of the substantial local processing of the STB hardware and allows for a much more scalable system, since in effect the creation of customized and individualized content based on the merger of standardized content (both industry-standard and system/MCO-standard) happens in a massively parallel fashion when it occurs at the STB level.

Turning now to the more real-time elements within the STB client system: Video content can arrive at the STB client via multiple means such as a built-in TV tuner decoding RF signals into digital data streams (84) or digital streams coming over a wired (typically Ethernet) or wireless (typically 802.11x) connection (86). Content can also be streamed from the hard disk of the device (82). In most cases hard disk content first arrived over the standard video (84) or network (86) and was looped back to the disk by via the DVR component (94). In all cases the content is normalized by the video source manager (VSM) (80) so that the remainder of the system is shielded from the details of different video formats and delivery mechanisms.

The junction point between editorial meta-data for video streams and the streams themselves is the Real-Time Meta-data Controller (RMC) (88). This module, upon receiving a command to play video from the HPM or APG, first determines what kind of stream is being requested (real-time or stored), associates the video stream ID with associated meta-data by calling the MDM interface methods, makes a fast determination about whether real-time playback is compatible with the meta-data for that program stream, and then either begins playback or else begins caching the real-time stream by calling the VSM (80) to utilize the DVR (94) to being making a stream copy.

The RMC logic depends on the interaction of a number of factors. The two most important factors can be considered as two independent variables whose correlation and interaction, when combined with user preferences (including reasonable defaults) determines the output of the video display system (90, 92) when the user requests that a video program be played.

The two factors are: (a) The nature of RMC's access to the video stream; specifically, whether it is available locally or “local enough” to allow skip ahead or even random access to the stream, versus a steady-state download such as the case of standard broadcast or a typical video-on-demand (VOD) service, versus a “start now” download that arrives at the STB client at an arbitrary rate. (b) The presence of various kinds of meta-data that interact with the different kinds of video streams in a complex fashion, as explained by the following definitions and table of interactions.

TABLE 1
Video Stream Types and Definitions

| Video | |
|---|---|
| Stream Type | Explanation |
| Real-Time | This kind of video stream is provided by“video |
| Standard | carousel” senders and is typical of live broadcasts and |
| Stream | VOD systems. Datagrams containing the (for example) |
| (RTSS) | MPEG-2 data packets arrive in an entirely one-way |
| | fashion using their own forward error correction and are |
| | surfaced to the video playing infrastructure at a rate |
| | very similar to the playback rate. RTS streams may be |
| | of indefinite duration. Because of the nature of best- |
| | efforts digital video delivery (whether over-the-air |
| | ATSC/HD digital broadcast, or IPTV UDP unicast/ |
| | multicast), some local buffering of data must occur |
| | since data display must be coordinated by a highly |
| | accurate local clock; but buffering seldom involves |
| | more than a few seconds of data. |
| Start-Now | This kind of video stream is sent on request by a “video |
| Indefinite | pump” that delivers the data on a non-synchronized, |
| Delivery | best efforts basis. The send may be unreliable/datagram |
| (SNID); types | (typically with forward error correction), or it may be |
| 1 and 2 | via a reliable connection-oriented protocol such as |
| | TCP/HTTP. The total size (in bytes) and playback time |
| | (in minutes/seconds) of the stream is sent as part of the |
| | initial response packet(s}, but the receiver has no |
| | further control over the ‘speed or ordering of delivered |
| | packets. Internet video delivery is typically of this sort |
| | (for example, MovieLink or YouTube downloads). A |
| | key sub-issue of SNID is the download speed, which |
| | can either be specified (as an estimate) by the sender or |
| | (more typically) measured by the receiver using a short |
| | sampling period (either an explicit sender-supported |
| | speed test, or simply by sampling the beginning of a |
| | “dumb” download). Based on the sample, the receiver |
| | can estimate the amount of time that must be buffered to |
| | ensure real-time playback. In the table below, SNID1 |
| | refers to the case where download speed is estimated to |
| | be greater than playback speedi SNID2 refers to the |
| | opposite case. |
| Stream Skip | SSF is a variation on SNID in which the receiver can |
| Forward (SSF) | specify that certain portions of the stream be skipped. |
| types 1 and 2 | This specification can be made either at the time of |
| | stream download initiation or (with more sophisticated |
| | senders) at any time, to be honored on a reasonably- |
| | likely but best-efforts basis. There are no known |
| | implementations today of SSF senders, but it would be a |
| | very simple enhancement to content streaming servers |
| | currently using SNID, and it would be very helpful to |
| | the system invention, and so it is broken out as a |
| | separate case. In the table below, SSF1 refers to the case |
| | where download speed is estimated to be greater than |
| | normal (no-skipping) playback speed; SSF2 refers to the |
| | opposite case. |
| Stream | SRA provides the most controlled kind of access to |
| Random | video streams. The receiver can “jump” at any time to |
| Access (SRA) | any part of the video stream(s)/sub-stream(s). The |
| | canonical example is playback from local permanent |
| | storage, such as a hard disk. However, access to content |
| | over a relatively fast/reliable network (for example, a |
| | home LAN with speeds well above the streaming speed |
| | of the medium) using remote filesystem-type methods |
| | (e.g., 5 MB/CIFS or NFS) also qualifies as SRA. |

TABLE 1
Meta-Data Types and Definitions

| Meta-Data Type | Explanation |
|---|---|
| Unknown | The program is unknown to the MDM. By default the |
| Program (UP) | program will not be displayed in the APG; if displayed |
| | by user choice, the default behavior will be to reject an |
| | attempt to play. (This default, and all other defaults |
| | mentioned in this table, can be overridden in user |
| | preferences.) In the case of non-SRA delivery: by |
| | default the system will not record the program for later |
| | viewing. |
| Program No | The program is known to the system but there is no |
| Data (PND) | meta-data beyond the industry-provided ratings data (if |
| | any). By default the program will not be displayed by |
| | the APG; if displayed by user choice, the default |
| | behavior will be to reject an attempt to play. However, |
| | in the case of non-SRA delivery the system will permit |
| | recording with the expectation that meta-data may be |
| | available at time of playback. |
| Program Rated, | The program is known to the MDM and ratings meta- |
| Insertions | data is available. No meta-data is available for |
| Unrated | “insertions” (typically advertisements or public service |
| (PRIU) | announcements, but the concept is generic in the |
| | system), however. By default the system will allow |
| | viewing/playback if the program rating is acceptable |
| | under current user settings (in other words, the system |
| | assumes that inserts have the same rating as programs; |
| | that assumption can be over-ridden). |
| Program Rated, | The program and insertions are both known to the |
| Insertions Rated | MDM and ratings meta-data is available for both. Both |
| (PRIR) | ratings will be evaluated independently and the |
| | program will be shown only if both meet or exceed |
| | current user settings. |
| Program Rated, | The program is known to the MDM, and rated in both |
| Real-Time Edits, | “raw” form and “edited” form. The metadata includes |
| Insertions | a list of “incidents” and optionally a substitution |
| Unrated (PEIU) | URI/URL (which allows things like a substitute sound |
| | track without profanity) and a “short incident” hint |
| | (usage discussed below). An incident is a time-based |
| | sub-program based on begin/end data. By default |
| | unrated insertions are assumed to be acceptable if and |
| | only if the “raw” program is acceptably rated; |
| | otherwise, the entire program will not be displayed. As |
| | an alternative non-default mode, the system will |
| | attempt to detect and skip insertions (or play |
| | alternative content). |
| Program Rated, | Same as previous, with the change that insertions |
| RealTime Edits, | ratings are independently evaluated against user |
| Insertions | criteria and the program is shown or not shown |
| Rated (PEIR) | accordingly. As an alternative non-default mode, the |
| | system will attempt to detect and skip |
| | insertions (or play alternative content). |
| Program Rated, | Same as previous, with the change insertions have |
| RealTime Edits, | their own incident list and editing instructions. |
| Insertions Real- | |
| Time Edits | |
| (PEIE) | |
| Program Rated, | Same as previous, with the change that in this special |
| Live Edits | mode the MDM indicates to the RMC that the relevant |
| (PRLE) | meta-data is not locally resident, but will be arriving |
| | on a semi-real time “as-needed” basis. This will |
| | alter the behavior of the RMC both in terms of default |
| | settings, but also in other ways discussed below. |

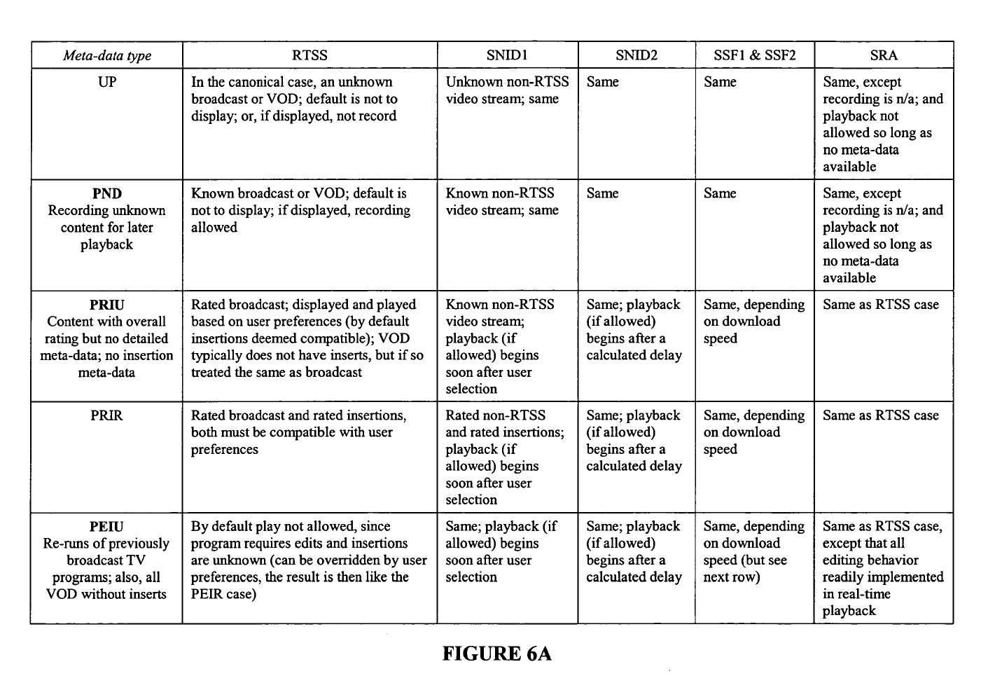

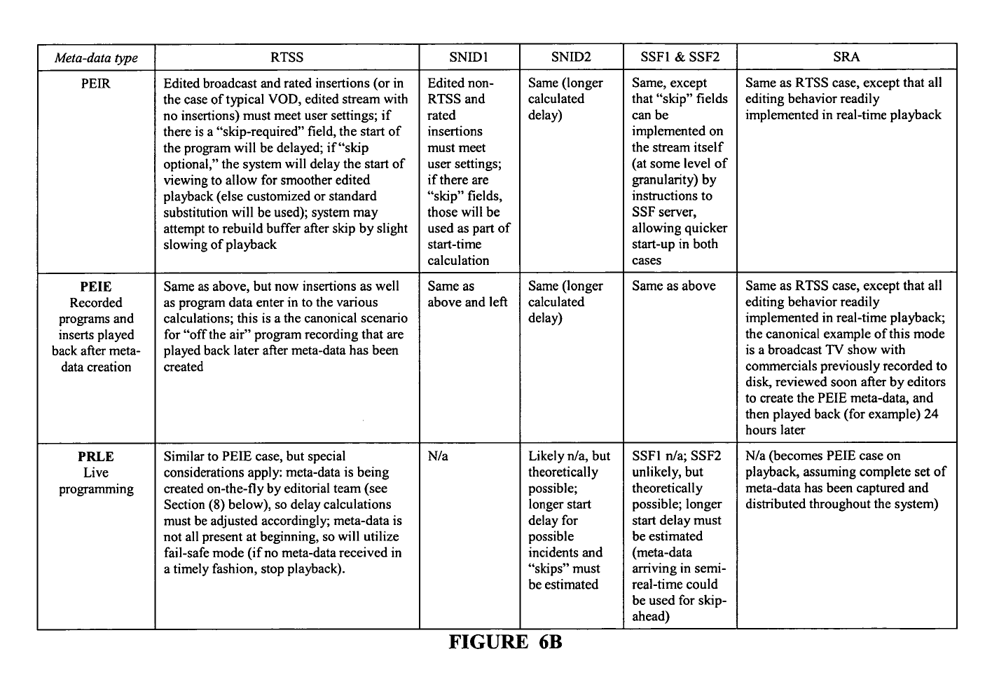

The two sets of factors interact in a variety of very complicated and often subtle ways. FIGS. 6A&B provide a table containing an overview of those interactions, usually in terms of system defaults (most can be overridden by advanced user preference settings). The abbreviation “n/a” stands for “not applicable,” which can refer either to an unreasonable usability scenario, or a technical impossibility, or both. The most common scenarios are given in bold-faced font in the “meta-data type” column, and the scenario is given a short description as well.

With regard to the algorithm used by the RTC to implement the above combinations of video delivery models and meta-data scenarios: At the start of non-PRLE programs (i.e., in those cases when all relevant meta-data is present at the start of program play), the RMC schedules system timer interrupts ahead of each incident event, as described by the incidents' meta-data. Upon gaining control prior to an incident start-time, the RMC queries the MDM and HPM for incident meta-data and user filtering settings and takes the appropriate filtering or blocking decision. Next, it either implements a “skip” instruction, or if given a “substitute” instruction it prepares the alternate media stream, and upon the arrival of the incident start-time, it replaces the original stream with the alternate one until the incident's end-time is reached. At this time, the original media stream is restored, and the program is completed normally. As noted, the RMC will also need to take into consideration media streams' retrieval and buffering characteristics, which are managed by the VSM.

Of course, all of this powerful and complicated technology will be rendered useless if someone in the user's household can easily by-pass the system by, for example, unplugging a co-axial cable from the back of the STB/DVR and plugging it directly into a TV set, thereby displaying all the analog channels without any controls in place. Or, a more sophisticated by-pass would be to plug the cable into a digital tuner of media center PC and view the entire set of channels available. While a simple physical by-pass cannot be prevented by the system for non-scrambled and/or non-encrypted channels, the system will certainly be able to know when its configure STB client is disconnected. The tier 2 server (24) will track its interaction with the STB (52) and will utilize (when necessary) a “heart beat” packet once every five minutes if there are no other communications packets pending to make sure that STB client is on-line and active. If the STB client cannot be contacted, this information will be noted and logged. The next time the STB client is connected, a system security warning will be placed on the system home page, indicating the loss of connectivity, and the date and duration. This information will also be surfaced to the account owner when he/she logs in via the system web server (06). These methods will ensure that if the system is physically by-passed, the account owner will be aware of the problem.

Finally, it is important to note that all this powerful and complicated technology is, in the end, an optional way of using the video system. The system owner/user with the correct administrative password can disable any or all of its features. Moreover, the owner can configure multiple sub-accounts such that different behavior will apply depending on which family member logs in to the STB client. The owner can also use time-of-day options to customize the behavior of the system based on family viewing patterns; for example, after 10 pm the system would be configured to a more “open” mode of viewing.

6. Affinity Groups and Meta-Data Creation Organizations

The last major technical component of the preferred embodiment of the invention is discussed in the next Section (7). To understand better the technical architecture, however, is it first necessary to understand the usage model and the “human architecture” of the system, so to speak. This section will discuss those non-technical aspects of the invention.

It should be clear enough what a “user” of the system is: an individual person or persons representing a family or household in their interaction with the system for video and Internet content management, aggregation, recommendation, and filtering. A large part of the power of the system, however, comes from the manner in which it is able to understand the user within a larger context or set of contexts. Those contexts are embodied within the system as “affinity groups” (AGs).

An AG is an organization known to the system representing a group of persons with whom the user self-identifies as in a member. An AG could be a church (or synagogue or mosque) group, a local community group, a parent-teacher organization, a hobby group, a sports-oriented group, or any other “civil society” group organized to help its members achieve worthwhile social goals. An “open” AG is one who allows anyone to join when becoming a member of the system; a “closed” AG is one for which the user must receive an invitation.

AGs have a strong incentive to join and promote the invention system and service because it provides the leadership of the organization with a way to serve their members and to promote their own activities. For example, registered AGs are able to provide their own video content as a “virtual channel” for their members. They can also (at the user's option) receive a special place on the users' Internet web pages (since in the preferred embodiment all user Internet interaction flows through a server or other device controlled by the system).

The primary value added by AGs is their provision to their members of system meta-data that either promotes desired content or blocks undesired content, or both. These two kinds of meta-data will be distinguished by referring to meta-data that promotes desired content (whether provided by the AG itself or, more commonly, by an unrelated third party) as “associative meta-data” (AMD) and referring to meta-data that limits or blocks undesired content as “subtractive meta-data” (SMD). AMD is used to highlight and promote content; it is not used to block or alter it. Conversely, SMD is used to block or alter content, depending on user settings vis-a-vis the SMD metadata.

Organizations that directly and technically interface with the system to create and provide meta-data in standard system formats are called MCOs (Meta-data Creation Organizations). AGs need not be MCOs. However, to participate in the system they should have a relationship with one or more MCOs and delegate to those MCOs the authority to create meta-data on their behalf. MCOs need not be AGs. They can be technically-focused organizations working on behalf of one or more AGs. They can create entirely different sets of meta-data for different client AGs (although there will likely be economies of scale for an MCO servicing multiple AGs since there is likely to be significant overlap in the kinds of meta-data that need to be created). Large AGs will typically also be their own MCO, but small AGs may contract with MCOs to provide the meta-data for their particular group of users.

That said, a small AG (such as a church group) could also be an MCO or partial MCO. It could contract with a more generic MCO to provide broad and deep coverage, but also have its own team of experts or volunteers who provide editorial meta-data to supplement the base meta-data. Since all that is required to do even real-time editing is a powerful personal computer, a fast and reliable Internet connection, and some training in the use of the editorial software, an AG could easily set up its own “cottage industry” of home-based workers doing editorial work—both recommendations and subtractive tagging—from their homes or offices. An AG could even establish a rotating team of volunteers who deal with media issues and choices every evening during “family prime time,” are available to “chat” with members over the Internet, provide real-time consultation and alteration of the system behavior with respect to Internet sites (both adding and subtracting sites from the generic “black list” by changing the AG meta-data), and so forth. An AG could also ask its members aggressively to give feedback on all media consumption so that the AG-specific meta-data grows rich and powerful very rapidly based on thousands of “eyes” providing input. The only limit to the ways in which an AG can help its members to enjoy, manage, control, and screen media content is the effort the AG is willing to put into enhancing the system.

Both AGs and MCOs are well-known entities within the data model and behavior of the system. The AGs are the crucial entities with respect to user membership, behavior, and desired outcomes of total system behavior. To the user it makes no difference whether his/her AG is an MCO or whether the AG contracts with an MCO to provide the desired meta-data. MCOs are the crucial “behind the scenes” entities with respect to the technical functioning of the system: how meta-data is authored, replicated, distributed, and used. To the system it makes little difference whether there is only one AG or hundreds of AGs; but the relationship with each MCO involves tight technical coupling and coordination.

The technical architecture and functioning of the meta-data system will now be described. For the reasons given, the entity discussed in the following section is primarily the MCO.

7. Editorial Tools and Models; Meta-Data Creation, Distribution, and Usage

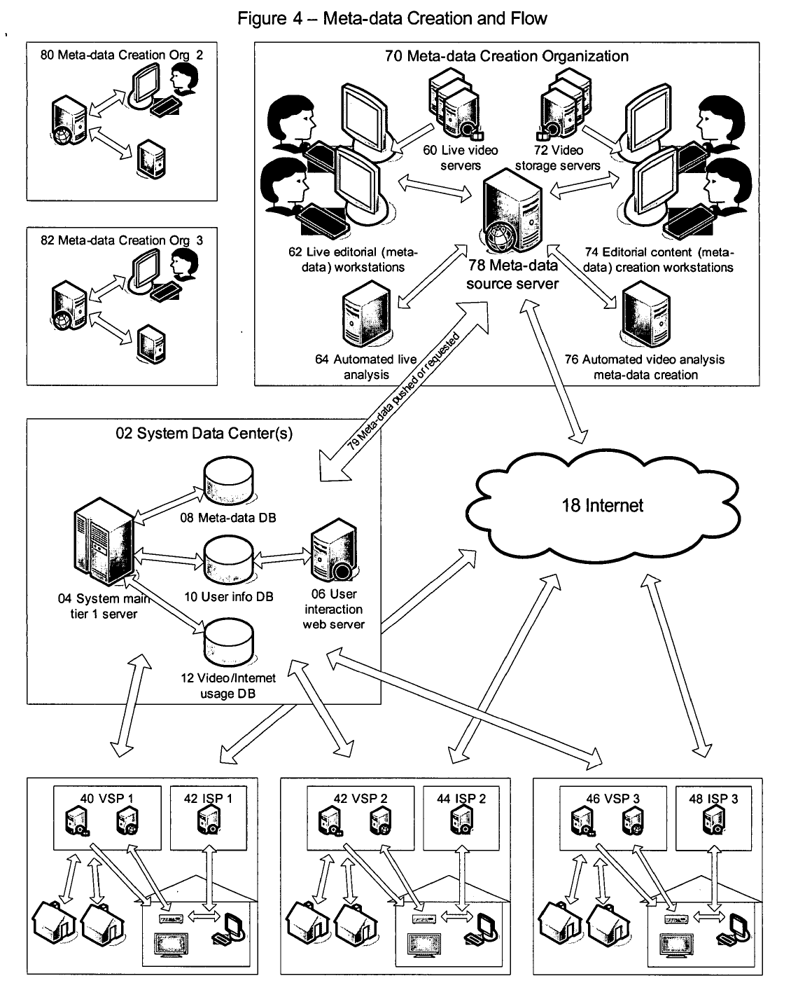

In its preferred embodiment, the invention includes meta-data creation organizations (MCOs) which create the meta-data that flows through the system to provide the desired outcomes to system users. FIG. 4 provides and expanded view of MCOs (70, 80, 82) and their relationship to the system as a whole. An MCO is an entity that creates meta-data and feeds it into the system. In order to provide value the system must have at least one MCO. However, there is no limit to the number of MCOs that can participate in the system.

There are two basic modes of operation for an MCO: real-time and non-real-time. The non-real-time mode is typical, necessary, and relatively straightforward; the real-time mode is optional and more difficult to implement. It is possible for an MCO to provide real-time meta-data services only, but in practice such an entity would most likely need to partner with one or more non-real-time MCOs because its standalone utility to users would be limited.

The non-real-time mode operates as follows. The MCO (70) obtains video programming (either directly from networks and other publishers, or by digital recording off of broadcast or other delivery mechanisms). The video programming is stored on servers with the requisite large amount of storage (72). Human editors then review each individual program using editorial content creation workstations (ECWs) (74) and create meta-data tags associated with the program's UUID and stored in a meta-data source server (78).

For example, a trained editor (or editors; an MCO may use multiple editors and tabulate their “votes” electronically to generate a final meta-data set) reviewing a program and following the MCO's policy guidelines (as created by the MCO or a related AG) will tag a particular scene in a program with AMD (associative meta-data) tag. The tag will specify the start and end times of the scene, some general information about the scene, and provide a label from a defined list with a reason or reasons why users may want to view that particular program and scene, such as its family-friendly humor or its exhibition of patriotic values, along with a “strength” indicator to reflect the editor's judgment of the importance of the program/incident. In another part of the program the editor may tag a particular scene with an SMD (subtractive meta-data) tag. The tag will again specify start and end times, general information about the program and scene, and then a label from a defined list as to why users might find the content objectionable in some way, such as sexual content or profane language. The severity of the incident will also be recorded according to the system's content rating scheme. This editing approach would be applied to not only program data but also “inserts” which are not permanently associated with the program (the canonical example is commercial advertising inserted throughout the program) but which may be de facto associated with it (for example, if users have recorded a broadcast program and intend to watch it played back later).

With regard to the crucial notion of “time” within the meta-data scheme: all digital video includes timing information since the delivery of packets is only approximately at the rate of playback, and so a highly accurate clock-based device (typically within the video display subsystem of the digital playback device) must use the time information transported with the digital frames to provide synchronize playback. In general, this time information is available to applications and will be used by the system and its meta-data tools and databases for universal time identifiers with respect to particular programs. The use of time codes also allows the metadata to be completely independent of the video to which it relates by sending instructions related to elapsed time, for example, of the media, instead of related to frames or sections of the video.

However, there may be cases where time information is not available in a universal or synchronized fashion. For example, a video program may be converted to analog and the converted back to digital, with the resulting loss of the data needed for precise synchronization. Or, a video sub-program (for example, the playback on multiple nightly news programs of a single video supplied by a terrorist organization) might be best viewed as “the same” sub-program, but the timing data will be different in all manifestations of the subprogram.

In such scenarios, the preferred embodiment of the system will use best efforts to create other reliable ways of tagging video streams with both unique IDs and relative repeatable time information. One possible approach would be to transmit with the meta-data (or tag in the primary meta-data with a URI and transmit asynchronously since this part of the meta-data will be relatively large) a time sequence of image digests (mathematical “summaries” of image data). On the STB client (FIG. 3, 52), the same algorithm used to generate the digests at the MCO (70, 80, 82) is calculated on the playing image stream. The resulting sequence can be used with a measurement model in a Bayesian filter to both initially estimate any timing offset between the metadata and the STB, as well as dynamically correct any temporal distortions that may arise during play. Aside from temporal distortions, the digest sequence can also be used to detect spatial distortions in playback (arising, e.g., to make room for a ticker to be displayed at the bottom of the screen), which is critical to the correct rendering of spatially sensitive metadata (e.g., blurring or blocking a portion of the screen). An essential feature of the digest is that it is continuous. That is, if two images are “close” then their resulting digests are also “close.” Digest functions that have this property have already been constructed and examined in the context of image watermarking. In that context, the digest is constructed from projections of the image onto a series of test images generated from a private key. In the system application of this method, there is no need for a private key, and so the system algorithm would have the freedom to choose test images to suit its purposes. As is also the case in image watermarking, the system would preprocess the images to its most essential features before calculating the digest—desaturating the image, applying the Sobel operator (to detect edges), and renormalizing, thus projecting out what might differ between images without being considered essentially different.

This digest-based approach for reconstructing “time-like” meta-data is computationally expensive, and so may not be applicable as a real-time method in the current generation of STB/DVR devices. However, as such devices gain more powerful microprocessors and programmable graphics processing units, this approach will become more and more realistic, and will be used in when either fundamental time-data is missing (rare) or (more commonly) to detect sub-programs that are “the same” even when embedded within different programs. Additionally, it may be used to verify that the program indicated is the program received (e.g., the correctly identified episode of a series), and take such actions as are necessary, such as blocking, warning, or identifying the material.

In addition to human editors working at ECWs (74), artificial intelligence software running separately (76) can be simultaneously scanning the video programming database and creating certain kinds of meta-data, or flagging items for closer human inspection. For example, a children's TV network with generally “safe” programming that is a low priority for the MCO to review with limited human resources could be scanned by AI tools and certain usual sound or video events flagged for human review and possible tagging. Automated tools could also pre-process video streams and create tentative markers for “inserts” which will streamline later human processing. Automated tools could also create image identification markers using hashing functions to allow video scenes to be recognized by the system as somehow the “same” despite having different program ID, timecodes, etc. For example, a video tape supplied by terrorists and integrated into the nightly news by many different news organizations could be flagged with its own unique ID by automated systems using the image digest algorithms described in the previous paragraphs and elevated to a first class entity within the meta-data system. As automated tools improve, they can be promoted to creating and entering directly into the meta-data source server (78) relevant meta-data that is then distributed throughout the system.

Potentially a large number of editors working at ECWs (74) supplemented increasingly by automated creation (76) could thus create a large amount of server-based meta-data (78) associated with pre-recorded video programming. This meta-data would be used throughout the system in the following manner.

Meta-data coming from one MCO would be pushed (79) on a regular basis into the system data center (02) and the meta-data database (08) via a private or virtual private network. Other MCOs (80, 82) would do the same. The system main server (04) would then associate meta-data by program and sub-program ID with the programming available at the different VSPs (40, 42, 43) served by the system. It would also analyze which AGs are represented within a given VSP site, as well as analyze the usage patterns and content feedback coming back from system users via the system via the tier 2 server (FIG. 1, 24). Based on this analysis, an appropriate subset of the meta-data would then pushed (FIG. 1, 14) to tier 2 servers within the VSP private network. From the tier 2 server the meta-data would then be pushed to STB clients, where it would be utilized by the Meta-Data Manager (FIG. 3, 40) to promote and/or modify content accordingly.

Alternatively, due to the inherently multi-stream nature of video content (e.g., MPEG-2 and MPEG-4 define a multi-logical-stream, single bit-stream transmission format), it is possible for the system to utilize the digital transmission of video as a means for distributing meta-data as well. The meta-data can be added to the video stream itself (preferably front-loaded so that the meta-data arrives more or less completely within the first few seconds or minutes of the content streams being delivered) at some up-stream part of the video distribution system. For example, meta-data could be added to programming at the VSP head-end (FIG. 1, 20, 22) by an insertion from the tier 2 server (24). One possible reason for this approach is that often there is dedicated bandwidth for video deliver that is not filled by the video content; for example, digital over-the-air broadcasting using the ATSC standards provides sufficient bandwidth for one high-definition (HD) and one standard definition (SD) encoding of all content, plus a small amount of additional bandwidth for signaling and other system uses. In the case where only HD or only SD content is being broadcast, there is ample “space” for meta-data to be added to the broadcast and rapidly delivered a potentially vast number of client systems in a reasonably reliable way (the ATSC and MPEG standards have forward-error-correction and other facilities for reliable data multi-casting in an unreliable network environment).

Turning to the meta-data usage model: It should be clear from the description thus far of the preferred embodiment of the system that a user can be associated with multiple affinity groups (AGs). In general, meta-data associated with different AGs (whether generated by one MCO or multiple MCOs) is additive: the user's meta-data is the total set of the meta-data of all AGs with which the user is associated. The question arises: how is the different meta-data associated with different AGs applied to the user when the meta-data conflicts in some fashion? For example, one AG rates an “incident” as severity 1, another rates it as severity 2, and a third omits it altogether.

The answer has two parts. First, the user associates with AGs in prioritized list, and the priority is used to reconcile differences in SMD as well as prioritize recommendations embodied in AMD. By default, the meta-data associated with a higher priority AG takes precedence over the meta-data associated with a lower priority AG. This prioritization applies equally to the AMD/recommendation and promotion side of the system as well as the SMD/filtering and blocking side of the system. Second, with respect to SMD, the user can optionally choose either a “most restrictive” or a “least restrictive” option or a level in between (e.g., an average of the AGs). In the “most restrictive” option, the AG meta-data that identifies more incidents and/or gives incidents a higher severity is given priority over all other AG meta-data. In the “least restrictive” option the conflicting meta-data is analyzed and lower overall ratings and lower incident severity ratings are given priority. Note, however, that in the case in which one AG has a record (such as a program record or incident record) that doesn't occur at all in the meta-data associated with other AGs, that record is treated on an additive basis and thus determines the outcome, regardless of AG priority. As a result, a sub-program (for example) that is unmarked by one AG and treated as an incident by a second AG will result in the second AG determining the outcome, since there is no meta-data conflict to resolve.

The system as so far described in this section depends on the analysis of recorded video by MCOs and its subsequent playback by the user in the presence of the relevant meta-data. This provides no benefit in the case of live TV “broadcasts” (however delivered), which is how most people still consume most video programming. In the following Section (8) the additional components and practices needed to deal with live TV within the context of the system are described. However, it is important to underscore just how valuable the system is even in the absence of any meta-data solution for live content.

(a) A unique part of the value of the system is not in the blocking and filtering features, but in the aggregation and recommendation features. All content, even if not pre-recorded and pre-screened, can potentially be part of the AMD/promotional side of the system.

(b) With regard to both AMD and SMD, the vast majority of video content is pre-recorded, and most of that pre-recorded content will be available for analysis by MCOs, either because it is a re-run of a previous live broadcast, or because it is a movie previously released in theatres or on DVD, or because through developing business relationships the participants in the system invention will be able to provide compelling business justifications to producers to make content available for pre-screening by MCOs.

(c) Finally, with regard to both AMD and SMD, individuals and families concerned about healthy media choices are now fundamentally empowered by DVR technology to dramatically decrease their consumption of live TV and to “time-shift” most of their video viewing to later, more convenient times. When combined with the system invention and an MCO business model with sub-24-hour turnaround for the creation of meta-data for all the main broadcast channels, the result is that by simply viewing television program one or more nights later, the user of the system can greatly expand their range of possible media consumption, find better content through the recommendations of AGs as embodied in AMD, while still feeling “safe and secure” and protected from undesirable content as embodied in SMD.

In short, even without any model or method for dealing with live TV programming, the system invention is still highly useful and valuable.

8. Live “Semi-Real-Time” Video Management Tools and Techniques

That said, it would be more useful if, in addition to all of the capabilities of the system discussed above, there was also a mode in which live TV programming could be brought within the system umbrella. This section as illustrated by FIGS. 3 and 4 describes the preferred embodiment of the invention when in its live mode of operation (the figure numbers are referenced only when relevant to the item number).

To summarize: The live video management mode takes advantage of the DVR capabilities of the client hardware and software, but instead of recording entire programs for later playback, the system uses the DVR function as a temporary cache for buffering live video and playing it back with a slight delay. During this delay period suitable meta-data will have been created and delivered to the STB client. The meta-data (received from the VSP or other sources such as Internet delivery) is then combined with the buffered live content and then played back to the screen. This mode is called the “semi-real-time mode” (SRM) mode for delivery of content to users.

SRM works as follows. Live content from a TV network is delivered to the MCO's live video servers (FIG. 4, 60) while simultaneously being delivered into the user's STB client (FIG. 3, 84). Because the STB client is running in “protected live” mode (as selected by the user when choosing to watch content either from the HPM (FIG. 3, 44) or the APG (FIG. 3, 42), the VSM (FIG. 3, 80) uses the DVR component (FIG. 3, 94) to make a local copy of the video stream without yet displaying it. The video is eventually displayed at a configurable interval between 60 (one minute) and 300 seconds (five minutes). For the remainder of this discussion the interval will be assumed to be 120 seconds (two minutes).

Meanwhile, one or more MCOs have implemented a parallel editorial/meta-data creation system for dealing with live content. Human editors working at one or more live editorial workstations (LEWs) (FIG. 4, 62) are watching the live broadcast. For reliability and accuracy these editors will generally work in teams of two or more, all watching the same content. (For the remainder of this description we assume that there is a team of three editors.) The LEWs have very specialized software that allow live video to be treated as though it were being played back for editing. So, for example, the editor can “pause” and “rewind” quickly and with great accuracy (to the frame level), “mark” or tag a frame as the beginning of a incident, “fast-forward” to the end of the scene/incident (if it has finished; if not to the current end of the stream) and tag again. The software has a sophisticated user interface allowing very quick application of meta-data tags and labels of the sort appropriate to live content. These tags immediately pushed into the meta-data source server (78) and treated as tentative meta-data records. The three editors are implicitly voting by all their choices and behavior. The system requires that at least two of the three editors agree on an incident before the meta-data is promoted to final state. (Automated systems (FIG. 4, 64) can also be used to enhance the quality of live video management; given enough time for enhanced AI techniques and given constantly increasing computational power, automated systems could eventually become equally if not more important than human editors.)

Once the meta-data has been created (and stored for subsequent use), it is pushed to a high priority local queue on the meta-data server (78) and the pushed from the local queue to the system data center (02) and the system meta-data database server (08) via a private or virtual private network link (79). From there the data follows two paths: (a) it is stored in the long-term meta-data database like all incoming meta-data; (b) it is placed into a high priority outbound local queue and then pushed as quickly as possible via a network link (FIG. 3, 14) to the tier 2 server (FIG. 3, 24) and from there multicast to all STB clients where it is received into a high priority processing queue by the MDM (FIG. 3, 40). The RMC (FIG. 3, 88), the component in charge of coordinated, meta-data-driven playback of all video (in this case a recently-buffered video stream), then plays the delayed video stream in the normal fashion by calling the VSM (FIG. 3, 80) and the MDM (FIG. 3, 40) and applying the meta-data as described above against a RTSS video feed. So long as the entire process of quick editorial tagging and network distribution of meta-data takes less than 120 seconds, the result of this process is that slightly-delayed local playback on thousands or possibly millions of STB clients is essentially under the remote control of the live editorial teams at the MCOs. The length of delay will be determined by many human and technical factors, and the invention is not limited to the length of delay.

There are two important differences in SRM video that the various system components must take into account and that differentiate it from the standard non-live cases. First of all, since meta-data is arriving on a “just in time” basis, it is critical that any networking or other failures (such as an editorial team literally falling asleep) that result in the cessation of meta-data flow be evident to the STB client in a timely fashion. This requirement is met by the use of an end-to-end “heart beat” data packet based on indicators of editorial team activity that flows once every 10 seconds from the LEWs (FIG. 4, 62), through the high priority queues on the meta-data source server (78) and system meta-data server (04, 08) to the tier 2 server (FIG. 3, 24) and on to the MDM (FIG. 3, 40) on the STB client. Failure of one packet to arrive creates an alert condition that suggests to the MDM that a system failure may have occurred. After some number of heart beat packets (in the case of a 120 delay, for example, this might be six packets or approximately 60 seconds) have failed to arrive, the STB client will “fail safe” and, depending on the current filtering level, may interrupt playback of the buffered content with an appropriate error message shown to the user (e.g., “this program can no longer play in ‘safe system’ mode”) and/or may superimpose the message in all or a portion of the screen. Of course, as an optimization when real meta-data packets are flowing they will be treated as heart beat packets as well.

Secondly, unlike the non-live case, it can be the case that an “incident start” record is created and transmitted with no corresponding “incident end” record available in time to allow the RMC (FIG. 3, 88) to make a normal decision about how to merge meta-data and video source. In that case the RMC will follow a policy as configured by the system and/or AG and/or user as to what alternative content to display for a period of unknown (at start time) duration.

There are two possible models for dealing with SMD incidents that, according to user settings, result in blocking of video content. In the first and simpler model, the STB client would simply display alternative content, such as a family picture, randomized clips from home videos, a message from one of the user's AGs, and so forth. This greatly simplifies SRM playback because the live video delay (and associated details, such as local buffer size) remain constant throughout the process. The RMC would still need to be notified of the need to provide substitute content so that it could prepare the alternative media to be substituted instantaneously and seamlessly when the “start incident” timecode applies to the playback stream.

A more complicated but more seamless model works as follows. The human editors could optionally tag the “incident start” event record with a special field that implies “likely short resolution” of the incident (“short incident”); alternatively, a separate but associated “short incident” record could be pushed out through the system within 10-30 seconds of the “start incident” record. (A real-world example of when such an approach would be useful is the news item from early 2007 in which a television football producer chose to broadcast nationally an extended (five to seven second) picture of a young women in the stands wearing a t-shirt with an obscene word emblazoned across it.) The implication of these “short incident” messages to the RMC would be to plan to simply skip the entire incident and not substitute any content. But these hints are optional because alternative content would still need to be queued up by the RMC in case the “short incident” hints turn out to be wrong. What is not optional is the arrival of the “incident end” message at the STB client prior to the time that the RMC has reached the “incident start” frame from the locally-cached video playback buffer, plus some additional time such that the buffer is not completely emptied, and could respond in principle to another “start incident” request. A reasonable minimum buffer size/time delay would be 30 seconds. If the RMC receives the “incident end” message prior to 30 seconds before playing the frame pointed to by the “incident start” message, it would simply skip over the incident altogether, and continue to play video with a 30 second buffer rather than a 120 second buffer.

The skipping part is relatively easy; what remains is how to manage the small buffer size. The small buffer size means the system is much more at risk of showing undesired content (in case a “start incident” message is not generated and received within 30 seconds of the real-time start of the incident in the broadcast TV stream). The STB client needs to rebuild the buffer to the configured size (minimum 60 seconds, default 120 seconds). There are several techniques that could be used to accomplish buffer expansion. One would be to simply slow down playback very slightly, for example, repeat a keyframe every second, thus causing a slight slowing of playback speed and gradually rebuilding the buffer. However, it would be difficult to rebuild the buffer quickly enough using slowing techniques without it being noticeable to the viewer that something was “wrong” with the video stream. Another more aggressive approach would be to insert an additional advertisement or two at the next advertising break. This would allow quick rebuilding of the desired buffer, although the opportunity for doing so may be some minutes away, and so the system will be running in a somewhat risky state in the interim. In its preferred embodiment, the system invention will use both techniques to rebuild the buffer to the desired time delay.

9. Internet Content Management and Filtering

Internet content management and filtering is a well-known and widespread technology. In the typical case content filtering software is installed on a personal computer and from then on will block access to objectionable website and also (typically) scan other kinds of network traffic (such as instant messaging and email) looking for keywords that indicate problematic usage of the system. Web traffic is usually filtered with one of two techniques (or both). (a) Every website requested by the user is first checked against a “black list” database of URLs compiled by the software vendor (or licensed from a third party); if the requested URL is found in the database, the software fails the request to view the site. (b) Once a site is allowed and the content downloaded from the web, the text (and sometimes graphics) of the requested page(s) is scanned dynamically for keywords and other indicators of objectionable content and the content is shown to the user only if the real-time scan indicates that the page is non-objectionable. With respect to non-web content (e.g., instant messaging, email, etc.) technique (b) typically is applied to all traffic. The software will often have different log-ins available for different users so that its behavior can be tailored to (for example) an age-group-appropriate level of filtering. In almost all cases the software can be disabled or bypassed at any time by anyone with the administrative password.

There are a number of problems with typical Internet filtering software products. First of all, they must be installed and configured on each individual PC. Since parents are typically not as computer-savvy as their children, this often results in the system being compromised from the start, since the very people that the software is supposed to protect are often able to control and disable it. Second, the software is often very obtrusive and problematic in usage, since it typically alters the behavior of system rather dramatically and often conflicts with other programs running on the same machine. Third, the software is only works on a specific set of operating systems; for example, most products in the market today work only on Microsoft Windows and provide no solution to users of Apple Macintosh or Linux computers. Fourth, and perhaps most importantly, all customization of the filtering software must occur by the user's configuration choices. The software's default behavior is “one size fits all,” and the result is that it doesn't fit anyone very well. Customization by individual users to suit the needs and values of their family takes a lot of time and effort, and often users get frustrated and simply shut off the software altogether.

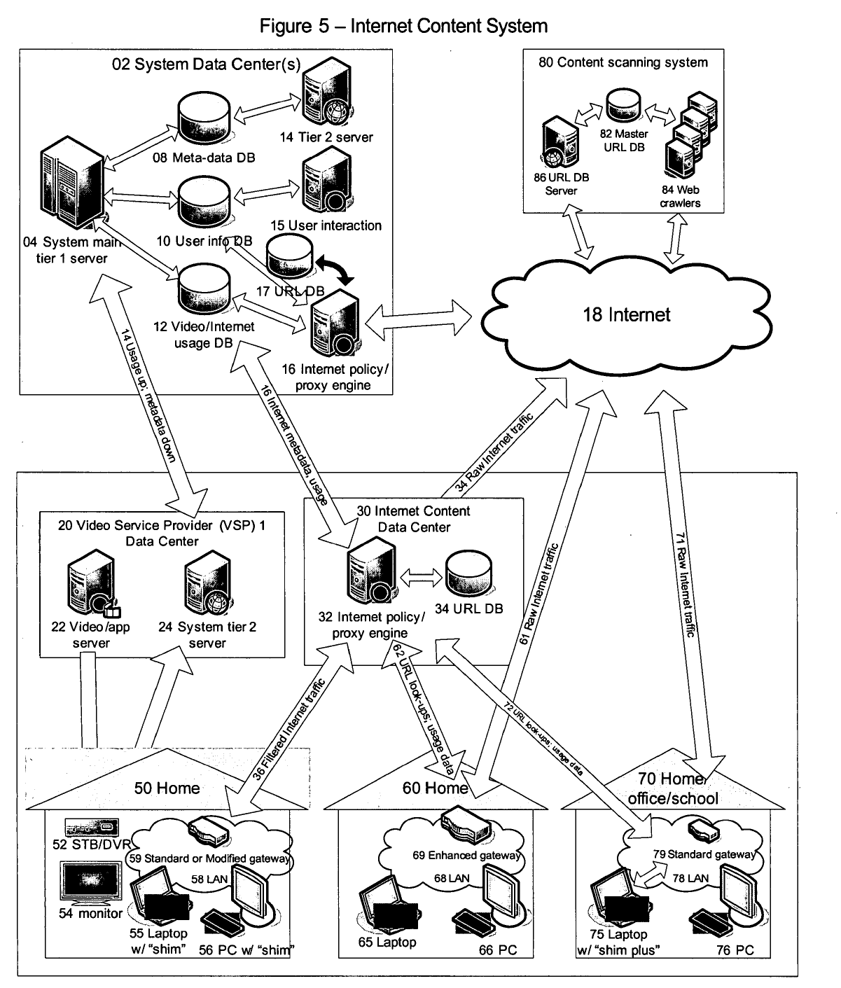

In the various embodiments of the system invention (FIG. 5), the Internet content management and filtering technology is not based primarily on the user's computer. Instead, the system exists in the network itself, thereby greatly simplifying and enhancing the behavior of the system. Perhaps most importantly, the system's knowledge of the user through the sign-up process and chosen affinity groups (AGs) provides immediate and dynamically increasing benefit in terms of tailoring and customization of the software to meet the needs of the user and his/her family.

There are three main embodiments of the system's Internet management and filtering technology. All three modes will be utilized, and all provide similar benefits and behavior. The three embodiments/modes are:

(a) Server-based: The preferred embodiment of the system is a completely transparent system built in to the user's Internet service provider (ISP) infrastructure. (This is the typical case for the system invention because the user typically receives both video and Internet service from the same provider, and as discussed in the preceding sections, the system is normally integrated into the VSP/ISP infrastructure.) Once the user is identified as a customer (50), all Internet traffic is routed through the system (30) and all management and filtering features are applied before Internet traffic ever reaches the home (36). An enhanced mode of operation (in which individual users and/or computers are differentiated) requires either a small additional piece of software on each computer,

(b) Gateway-based: Another, similar approach places the system intelligence in a smart gateway device (“enhanced gateway” or EG) (69). This approach is equally transparent and works even when the user's ISP has no knowledge of or relationship to the system invention and so all Internet traffic reaches the home (60) in a “raw,” unfiltered fashion (61).

(c) Shim-plus-based: The final, least favored approach is based on putting a very “thin,” simple piece of software known as a “shim” on the user's computer. This particular shim must have more functionality than other shims discussed in this detailed description, so it is hereafter called “shim-plus.” The advantages and disadvantages of this approach are discussed in greater detail below, but the primary advantage is that the user's computer (55) is “protected” wherever it is (50, 70) and however it connects to the Internet (36, 71). This approach thus is particularly important in the case where the user wants a portable family computer such as a laptop (55) to be “within” the system no matter where or how it connects.

In all embodiments the system's features and protections can be by-passed given the necessary security credentials. However, even the by-pass operation is enhanced in various ways, as discussed below.

The behavior of the system will first be discussed in detail in its preferred, “server-based” mode/embodiment. Next, the advantages of a group-oriented Internet content management and filtering model will be highlighted (this applies to all modes of usage). Finally, the additional two technical modes/embodiments will be discussed in terms of their differences (any features or functions not discussed remain the same).

a) Server-Based Mode

The system's content management and filtering capabilities begin with the use of humans and/or automated systems to scan large amounts of Internet web content, to evaluate it according to a number of industry-standard categories, and to create a URL-based meta-data database that contains this large information set. In the preferred embodiment, a system of automated “web crawlers” (84) (large and powerful computers constantly scanning the web for new content) with appropriate artificial intelligence (AI) software scan web pages and rank the page based on a prediction of whether the page includes possibly objectionable content. This information is stored in a master URL database (82) and is periodically replicated to slave URL databases (34, 17) for usage by the system.

In the next logical step, the user's account information including family members, ages, sensitivity levels for each family member, and affinity groups (AGs) is analyzed by the Internet policy/proxy engine (32) and policy profiles are created that allow for very quick decisions about whether a given Internet usage request is permitted or denied. AGs can create their own customized “black lists” (URLs that contain questionable content) as well as “white lists” (URLs that are considered safe and desirable). The “white-listing” of a URL by an AG will override the “black-listing” of the same URL by a generic engine such as (80). To give an example of this customization: web pages based on traditional readings of the Qur'an or Bible containing criticisms of certain alternative lifestyle behavior or certain kinds of sexual behavior are often labeled as “hate speech” by generic web URL databases. An Islamic or Christian AG can either accept this labeling or may instead override the labeling with respect to certain web pages by adding those pages to their “white list.” This is presumably what the user who associates himself/herself with that AG would expect and want. Thus, the system is immediately adding value to the user experience above and beyond a generic Internet filter.

In the fully protected home environment (50) all Internet traffic is routed through the Internet policy/proxy engine (IPPE) (32). Web sites on the “black list” are evaluated against user configuration and allowed or blocked. Web sites on a “dynamic sites list” (sites that have constantly changing and far-ranging kinds of information, some of which is may be quite objectionable to some users, much of which is not) are evaluated on a real-time basis. That is, each page is scanned as it is downloaded by the IPPE and passed through to the requesting client only if it meets the criteria established by the real-time scan. Beyond web usage, all other user-level protocol traffic—email, instant messaging, Internet gaming channels, etc.—is scanned in real-time.

In one common configuration, no per-user information is utilized by the IPPE; all requests coming from the household are accorded the same treatment. These household-wide policies are applied to web, instant messaging, and email traffic, and other popular user-level Internet protocols. Only when a URL is blocked is the user presented with a by-pass screen, where administrative or parental credentials can be used to by-pass the filter temporarily (be default, only for that single URL, but optionally for a short period of time).

This pure server-based approach is extremely easy to use and configure because no software need be installed on any computer in the protected home (50). It is completely automatic and safe. It can protect the user not only from objectionable content, but also from undesirable content (such as web page pop-ups) and dangerous content (such as viruses and “phishing” schemes). (The user can even be made aware of the fact that they are using the Internet in a safe mode because the system can inject into each web page a script that displays a “safe browsing” icon on the screen of the web browser.) However, a purely server-based approach does limit some of the desirable options. For example, it would be desirable for different computers in the protected home (55, 56) to have different policies in effect depending on the user. Because in the normal case the IPPE is unable to distinguish between client computers behind a standard gateway (59), this level of customization is not possible.

The system can, however, provide per-user and per-computer levels of customization by the use of a small amount of additional software on each computer in the home. There are three possible approaches here. The simplest one from a development and deployment perspective is to utilize existing virtual private networking (VPN) technology that exists in all modern client operating systems. In particular, Windows, Macintosh, and Linux computers all include the simple VPN technology known as “point-to-point tunneling protocol” or PPTP. The identity of each computer and/or user can readily be established in a secure fashion by requiring the creation of a PPTP tunnel between the client computer (55, 56) and the IPPE (32).

There are drawbacks to the use of a technology like PPTP, however. First of all, there is some additional computational and networking overhead in the protocol, although that alone is probably not a sufficient reason not to use it. Secondly, the user model is more complicated since the user must utilized commands and utilities in the operating system that he/she is probably not familiar with. Some of that burden could be ameliorated or eliminated by the downloading through the client system web browser of a small piece of client software that automates the creation of PPTP tunnels as well as making the log-in process more like a web server log-in, as users are accustomed to doing for themselves. Third, PPTP may not be supported in the scenario where a portable computer (55) is taken outside the home and used in an arbitrary location and network (70, 78); some gateways block PPTP traffic. Finally, the PPTP solution would be very inefficient in terms of network traffic in any case where the PPTP server is not directly on the user's path to the Internet. In other words, in scenarios like protected home with an arbitrary ISP (60) or an arbitrary location/network connection (70), PPTP would route all traffic through the IPPE, which is likely not be as fast or efficient as sending only needed traffic to/through the IPPE while letting the bulk of data flow directly from the Internet (61, 71) to the home (60) or other location (70).

Thus, in its preferred embodiment the system provides one of two other possible approaches that meet the requirements of the system without requiring the overhead and complexity of a VPN-based solution to the problem of user and system identity.

In the first preferred approach, a small layer of software called a “shim” is added to each client computer. (In function and operation, this is a different piece of software from the video-system related “client shim” layer discussed in Sections (1) and (5); and it simpler than (essentially a subset of) the “shim-plus” discussed below. But in implementation and deployment these three pieces of software would likely be combined, and almost certainly the “shim” discussed in this section would be combined with the “shim-plus” discussed below.)

In the case of the protected home (50), the only function of the shim would be to manage user and session identity. For example, when a particular computer is used for the first time after a period of inactivity, the shim would notice that no valid system session existed and would redirect the first URL request to the IPPE for a system log-in via web page supplied by the IPPE. Once the session is established (sessions are of configurable length, the default is 30 minutes), the shim would insert a session ID into each packet and the IPPE would then be able to apply the appropriate per-user policies to all Internet requests before stripping out the session ID and sending the request on to the Internet as usual. (Replies would not need to be modified or directly handled at all other than for real-time scanning (see below), as the return path to that particular client is pre-determined by the reply IP address/port number combination managed by the gateway and the client system itself.) Sessions will be set to time-out periodically (based on a short period of inactivity (such as five minutes), and even periodically when sessions are active (such as once every 30 minutes) to protect against the case where one user starts using a computer immediately after another) so that user IDs are likely to be correct.

Another, more seamless way that the system can maintain user/session identity is by a slightly modified gateway device called a “modified gateway” (MG) (59). In this case the MG provides only one additional function (and associated setup routines), which is to provide a mapping between computer IDs on the LAN (represented by MAC address) and the use of a specific range of reply ports for Internet requests. There are approximately 63,000 dynamic port numbers available for replies to requests made according to any Internet protocol. A “network address translation” (NAT) gateway device (the type almost always used in home network environments) normally uses these port numbers to provide a private mapping between private LAN IP addresses and public IP requests. In this embodiment of the system, that mapping is utilized to provide a means by which the private ID of the computer behind the NAT can be communicated to the IPPE in an extremely efficient, seamless manner.

This part of the invention works as follows. When the MG boots and has an Internet connection, it connects over the Internet using a secure channel to a system server in the system data center (02) at a well-known DNS name and registers itself as part of the system. If its source IP address is within a VSP/ISP network in which a system Internet Data Center (30) is present, the MG is informed of that fact and also sent the IP address of the IPPE for that network. (The IPPE is also informed asynchronously of the presence of the MG as identified by its MAC address (which functions as a UUID) as well as its current IP address.) If its source IP address is not part of a managed environment, the MG does nothing further. It makes this check each time it boots, and also once per day in case of configuration changes. (Most likely the check will succeed, as the user will not have purchased or otherwise acquired an MG unless they expect to use it within the system. However, the gateway could be taken out of the system and it will function normally.)

If the MG (59) is within an environment serviced by an IPPE (32), the two nodes work in a simple partnership that enables the IPPE easily to identify particular PCs within the private LAN (58). If the MG has previously connected to the IPPE but lost its configuration information, that information (including previously configured MAC addresses and associated reply port ranges) is downloaded at this “initial” log-in and the partnership continues as before.

The partnership between MG and IPPE is initially created as follows. The basis of the partnership is (a) the communication of internal MAC addresses to the IPPE under special, occasional circumstances; and (b) the constant usage by the MG of a range of reply ports to uniquely identify requesting computers/devices by MAC address within the LAN.

The first part can be accomplished in a variety of ways. In the preferred embodiment, the user is requested to connect to their system account from each computer on their LAN and then to click on a special URL. The MG is always watching for a GET request to that particular URL. When it sees such a request, it incorporates the MAC address of the requesting computer (in encrypted fashion) into the request URL, and from that point forward (if not before, see next paragraph) it uses a dedicated set of reply ports for all outbound requests from that particular computer. For example, for computer X/MAC address Y, the MG will always use reply port numbers 2501-3000 (this block would have a simple identifier, such as “block 3”). (The number of ports in a block can be modified based on system experience, but it is expected that 500 ports is more than adequate for normal home computer usage, since it is extremely unlikely that any home computer will have more than 500 TCP connection or UDP sessions active at any one time.) Since there are about 63,000 port numbers available, this would allow the MG to communicate unambiguously the identity of more than 120 devices on the LAN to the IPPE simply by setting the reply port to a specified range. From that point forward, and with no further overhead or overloaded data inside packets, the IPPE can easily determine what computer is making the request, and handle session and identity issues accordingly.

To summarize: the server-based mode of the system invention provides completely seamless, “hands-free” protection of the entire home LAN (58) without any software changes to local computers or any other technical intervention. The only thing that the user needs to do is sign up for the service via the VSP/ISP (20) or the system user interaction server (15). Once the user is known to the system, all Internet traffic from their gateway device (or, more accurately, the cable modem or DSL or fiber-to-the-home bridge) will be routed by the VSP/ISP through the system's “local” datacenter (30) and a pre-assigned IPPE (32). The system protects the home as a whole, even if someone brings in a computer that has never before had any interaction with the system, and has no software installed by or from the system. However, should the user desire further customization, such as per-user and/or per-computer settings on content management and filtering, the installation of either a client “shim” or a modified gateway (MG) (59) will allow such customizations in a simple and seamless manner.

b) Major Advantages of the System Over Traditional Internet Filters

Before discussing the two other technical system modes, and in addition to some of the technical advantages provided by the system as discussed above (such as “entire home” protection) and below (centralized management of all Internet-connected devices associated with the user/home/account), it is important to pause to highlight the non-technical ways in which the system invention (in any mode) provides a major improvement in usability over all existing Internet content management and filtering technologies. There are two key factors that make the system much more powerful and easy to use than previous systems. One is the existence of Affinity Groups (AGs) and their relationship to the user and his/her family. The other is the connection to the user's video system.

The presence of AGs within the system allows for much more customized and desirable user experience. For example, consider a web page that is listed by the generic web filter as containing objectionable content. Sometimes web pages are listed as objectionable when they simply are not (simple false-positive). In other cases the web page would be objectionable to some members of society, but not to members of one or more AGs (context-based false positive). If a user of a standard Internet filter encounters such a page, he/she has no basis on which to know whether to unblock the page for his/her or own viewing, or his/her child's viewing. Thus, every blocked page presents a dilemma—“I think this page could be ok, but then why is it in the ‘black list’ database?”—without any context for resolution.

Now consider the same scenario within the system invention. First of all, as previously discussed, AGs can develop “white lists” that override the system-wide “black list.” From the start the system will be more customized to user preferences and expectations.

Secondly, the system grows more customized dynamically by simple use. The first time someone from a particular AG chooses to view a blocked page, that choice is noted in the usage database, and they are sent pop-up request asking them to rate the page and (optionally) describe why they found it useful, neutral, or harmful. Their response is logged by the system. After awhile a “collective intelligence” emerges from system usage. For example, the 100.sup.th user who encounters the blocked page will be told that “70% of members of your affinity group X clicked through this blocking page by entering the administrative password; of those, 10% were glad they did, 20% were neutral, and 70% regretted it. Click here to read their comments, sorted by most recent to oldest.” In addition, aggregate behaviors will be reported to the staff of the AG and they can then take action to serve their users by either adding a URL to their “white list,” or creating a special annotation for the page that explains to their users why or why not they might want to use the page or the entire site. The system will show that annotation in place of the standard block message when members of the AG encounter the questionable URL.

There is almost no limit to the kinds of user help and customization that can emerge from the system design, the aggregation of usage data, voting by users on content, and the continual feedback of usage and AG input into the system to further refine and expand its recommendations and support for intelligent Internet and media choices by users.

The other major area of improvement brought about by the system invention comes from its ability to couple together video and Internet services into a single user experience. This begins with the fact that the user provides a set of information about himself/herself and his/her household as well as affinity group data that is shared across the two interconnected systems. The integration increases with usage, since choices made on the video system can have a positive, customizing impact on the behavior of the Internet system, and vice versa.

Integration is also key to improve reporting and feedback to the user. For example, the parents of a family can receive weekly usage reports on both video and Internet usage: how many hours the family spent watching TV, and when; the top-rated web sites and web searches, as well as the amount of time spent on instant messaging systems and web-based email, and/or the number of email messages sent through the system's integrated email system as well as arbitrary SMTP and POP/IMAP gateways. The system can also report suspicious outages: times when either the video management system and/or the Internet management system were not operational (under certain scenarios the system could be by-passed, such as a STB client connected to a traditional co-axial cable with analog channels, or the Internet system when configured to work in Enhanced Gateway or “shim-plus” mode). The system can also signal to parents via an icon on the TV set when there are real-time problems with Internet usages, such as an unusual spike in block sites, or an unusual number of times the administrative password has been used to by-pass the filtering system.

c) Enhanced Gateway and “Shim-Plus” Modes

Returning to the technical architecture: the system has three main Internet usage modes. The first and most comprehensive mode—so-called “server-based mode”—was discussed above, along with a number of generic features and advantages of the system. Two other modes will now be discussed: enhanced gateway mode, and “shim-plus” mode. Unless noted here, all previously noted features and advantage of the system are carried over to these two modes of operation.

Server-based mode works in those circumstances in which the system is working in collaboration with the user's ISP—in other words, when all the user's Internet traffic can automatically be routed through the systems Internet Policy/Proxy Engine (IPPE). Some users of the system may not have an ISP that is working in cooperation with the system. This can happen when the user's VSP is not their ISP; or if the user is using the video system in on of its alternative modes of operation (see Sections (2) and (3) above).

In this case, the user will have the option of acquiring an enhanced gateway device, (EG) (69) which provides all the necessary functions for the system. The EG provides a number of additional functions beyond the simple computer/user identification function provided by the modified gateway (MG) (59).

Like the MG, the EG will first contact the system data center (02) and after logging in securely, will receive the information needed to find and connect to the “closest” IPPE (32 or 16). From that point forward, the role previously played almost entirely by the IPPE will now be split between the EG and the IPPE. The EG can be thought of as some of the modules of the IPPE that have been split off and configured to run on a small computer acting as the network gateway for the home (60) that work in close partnership with the remaining modules of the IPPE on the server (32, 16).

Here are some of the functions of the IPPE now performed altogether or in part by the EG. In conjunction with the user interaction server (15) and the IPEE, the EG will manage system and user identification as well as session management. When the user interacts with the system via the web (15), the EG will transparently add information about the in-home LAN (68) as well as the connected computers indexed by MAC address. The user will be able to configure the settings for particular computer, and the EG will learn and remember the default settings for each. The EG will also provide session time-outs and request that user log in after a certain period of inactivity, or periodically even during regular activity. The EG will provide real-time scanning of email and instant messaging traffic, as well as web traffic to “dynamic” sites, and security scanning for virus, phishing schemes, and so forth. The EG will not keep a full copy of the URL database (34), nor of all the meta-data provided by AGs. Instead, the EG will forward each URL request to the IPPE, and keep small FIFO cache of URLs and associated meta-data in-memory, with an age-out timestamp on each entry of a few hours, so that information remains fresh. Finally, the EG will upload regularly its local database of user interactions and user and system information so that the system can utilize and store this information reliably. If the EG, for example, somehow crashes or is reset to factory defaults, the system will download all of the previously “learned” configuration data to the EG when it logs in again.

The key thing to keep in mind about the EG architecture is that the EG is only making “look aside” calls to the IPPE. The bulk of Internet traffic up and down is going directly from the EG to the Internet. Video streams or other large downloads, for example, once approved by a “look aside” to the EG URL cache and, if necessary, a remote call to the IPPE, are simply streamed through the EG without any other intervention by or through the system.

The “shim-plus” mode provides a means by which a portable system such as a laptop (55, 65) can be configured from within the system to operate in a safe and integrated manner even when it is connected to the Internet from an arbitrary location (70) that is lacking both server-based and EG-based content management and filtering. Technically speaking, “shim-plus” mode is similar to EG mode, but in the shim case the situation is simplified somewhat because the shim is tracking and managing the behavior of only a single system, not multiple systems on the LAN. But in other respects the shim acts very much like the EG, as a kind of distributed component of the IPPC.

More specifically, when installed on a PC (55, 56) the shim watches all local interactions between client applications (such as web browsers, email programs, instant-messaging programs, etc.) and the TCP/IP networking protocol stack. Some of those interactions would be intercepted temporarily and communicated to the IPPE (32), which would then return a result that blocks or permits the interaction. Others are permitted without intervention. Still others involve real-time filtering and analysis, such as the filtering of instant messages and email traffic.

In order to fit in with the remainder of the system in as seamless a mode as possible, the shim has no separate user interface. All configuration of the shim is done by configuring the machine and its users on the system web site (15), with all the configuration data stored in the user information database (10). This approach has several advantages. First of all, the account owner can track, configure, and reconfigure all computers associated with the account, regardless of their current location. For example, if a child takes a laptop to school, the parent can make configuration changes that automatically propagate to the laptop the next time it connects to the Internet. Going the other direction, all usage information and incidents (such as blocked websites) are uploaded to the user account and integrated into a single viewing and reporting architecture for all computers associated with the account.

Finally, both the EG and “shim-plus” are designed so that if they are temporarily removed from the home or the computer, the system will recognize their absence. This “dog that didn't bark” kind of knowledge is of course ambiguous since there are many reasons why a device may have been off-line. Nevertheless, it will give to parents some assurance that the devices were in use when necessary, since a long gap in the connection times of the EG or the shim may be difficult or impossible to explain in light of other facts known to the parents.

It is to be understood that the present invention is not limited to the sole embodiment described above, but encompasses any and all embodiments within the scope of the following claims.

We claim:

1. A method of customizing playback of media content from a set top box onto a video display device to prevent unauthorized users from viewing portions of a video stream, comprising:
a video service provider broadcasting a video stream to a user's set top box at the user's premises;
temporarily storing said video stream on said set top box;
at least one content editorial reviewer remote from said user's premises reviewing said video stream and rating portions of said video stream into at least a first and second category;
said set top box receiving the rating information from said at least one content editorial reviewer and associating the ratings with portions of said video stream;
an authorized user at said premises selectively changing a playback mode of said set top box to skip portions of said video stream in said second category unless an authorization code is entered into the playback;
withholding the authorization code from an unauthorized user;
initiating playing back of said video stream on said set top box;
said set op box automatically displaying only said portions of said stored video stream on a video display device at said user premises rated by said content editorial reviewer as category one and automatically skipping portions of said playback rated as category two when said authorization code is not entered prior to playback; and
said set top box automatically displaying all of said stored video stream on a video display device at said user premises when said authorization code is entered prior to playback.
